(19) United States
(12) Patent Application Publication
(10) Pub. No.: US 2015/0127185 A1
(43) Pub. Date: May 7, 2015

(54) POWER SUPPLY-DEMAND CONTROL METHOD AND POWER SUPPLY-DEMAND CONTROL APPARATUS

(71) Applicant: Panasonic Intellectual Property Management Co., Ltd., Osaka (JP)

(72) Inventor: MAHDI BEHRANGRAD, Osaka (JP)

(21) Appl. No.: 14/530,785

(22) Filed: Nov. 2, 2014

(30) Foreign Application Priority Data
Nov. 7, 2013 (JP) 2013-231567

(51) Int. Cl. G05F 1/66; H04L 29/08; G05B 15/02

(52) U.S. Cl. CPC G05F 1/66; G05B 15/02; H04L 67/10
USPC 700/297

(57) ABSTRACT

A power supply-demand control method is related to a method of a power supply-demand control system configured to adjust power supply-demand between a consumer and a power system by controlling electric equipment via a communication network during a supply-demand adjustment period. The power supply-demand control method includes receiving a request for changing the operation mode to a second operation mode higher in power consumption of the electric equipment than a first operation mode when the electric equipment operate in the first operation mode, in which power consumption of the consumer is suppressed, during the supply-demand adjustment period, and determining whether to permit the operation mode to change from the first operation mode to the second operation mode if a request for changing the operation mode to the second operation mode is received.

### BACKGROUND

1. Technical Field

The present invention relates to a power supply-demand control method and a power supply-demand control apparatus.

2. Description of the Related Art

Systems have been under study recently to adjust power supply-demand between consumers and a power system. The adjustment in the power supply-demand is referred to as a demand response. Japanese Unexamined Patent Application Publication No. 2004-007856 discloses a technique as one example of the power response. In the disclosed technique, power consumption in a consumer is suppressed to control a power peak during a predetermined period, and power corresponding to suppressed component (hereinafter referred to as “negawatt”) is traded between power producers.

The related art technique has still room for improvement.

### SUMMARY

The disclosure is thus directed to a power supply-demand control method to allow a consumer to select whether to cancel power suppression in response to a cancellation request of the power suppression from the consumer during a power supply-demand adjustment period.

In view of the situation, one non-limiting and embodiment provides an improved power supply-demand control method in comparison with the related art.

A power supply-demand control method in one aspect of the disclosure is related to a power supply-demand control method of a power supply-demand control system configured to adjust power supply-demand between a consumer and a power system by controlling electric equipment via a communication network during a supply-demand adjustment period. The power supply-demand control method includes suppressing power consumption of the consumer below a power consumption level prior to a start of the supply-demand adjustment period by changing an operation mode of the electric equipment in operation to a first operation mode if the supply-demand adjustment period starts in response to reception of a reduction request requesting the consumer to reduce power consumption, and selecting whether to permit the operation mode to change from the first operation mode to a second operation mode higher in power consumption of the electric equipment than the first operation mode if a request for changing the operation mode to the second operation mode is received with the electric equipment operating in the first operation mode during the supply-demand adjustment period.

A general or specific embodiment may be implemented using a system, a method, an integrated circuit, a computer program or a computer-readable recording medium, such as a compact-disc read-only memory (CD-ROM), or may be implemented by the system, the method, the integrated circuit, the computer program and the computer-readable recording medium in any combination.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF THE DRAWINGS

FIG. 1 illustrates a configuration of a power supply-demand control system and a flow of information in the configuration in accordance with a first embodiment;

FIGS. 2A and 2B illustrate a change in power consumption of a load when the power consumption of the load resumes a state prior to a power suppression period in response to a cancellation of power suppression during the power suppression period;

FIG. 3 is a block diagram illustrating a power supply-demand control system of the first embodiment;

FIG. 4 is a flowchart illustrating a power supply-demand control method performed by the power supply-demand control system of the first embodiment;

FIG. 5 is a flowchart illustrating the power supply-demand control method performed by the power supply-demand control system of the first embodiment;

FIG. 6 is a flowchart illustrating cancellation control performed by the power supply-demand control system of the first embodiment;

FIG. 7 illustrates information related to an input to and an output from a server of the first embodiment;

FIG. 8 illustrates information related to an input to and an output from a controller of the first embodiment;

FIG. 9 is a flowchart illustrating of a determination process of permitted power performed in accordance with a rule of cancellation;

FIG. 10 illustrates power consumption in a load with the power suppression canceled and the concept of a margin that is a difference between a first reference value and a second reference value that results from subtracting a target amount of suppression from the first reference value;

FIG. 11 is a flowchart illustrating an example of a determination method of a risk of nonfulfillment;

FIG. 12 illustrates a specific application example of the power supply-demand control system of the first embodiment;

FIGS. 13A and 13B illustrate a change in load power consumption in a first consumer and a second consumer in a case C;

FIG. 14 is a block diagram illustrating a power supply-demand control system of a second embodiment;

FIG. 15 is a flowchart illustrating a power suppression control method performed by a power supply-demand control system of the second embodiment;

FIG. 16 is a flowchart illustrating second cancellation control of power suppression performed in the power supply-demand control system of the second embodiment;

FIGS. 17A and 17B illustrate a change in the load power consumption in the first consumer and the second consumer when the power suppression control method of the power supply-demand control system of the second embodiment applies to the case C of the first embodiment;

FIGS. 18A to 18D illustrate a specific example of a display screen displayed on a display implemented by an interface;

FIG. 19 is a flowchart illustrating the cancellation control of power suppression performed by the power supply-demand control system of the second embodiment; and

FIGS. 20A to 20C illustrate a specific example of a display screen on a display implemented by an interface.

### DETAILED DESCRIPTION

### Underlying Information of Disclosure

The inventors have found that the power supply method described in the section of the “Description of the Related Art” suffers from the following drawback.

If a modification to reduce power consumption on a load in a consumer is introduced to minimize a power peak in response to an instruction from the outside, such as an instruction from an aggregator, performance of the load is decreased. For this reason, comfort provided by the load or the functionality of the load is also decreased. This leads to causing consumers having these loads to cancel power suppression.

On the other hand, in a system that has been under study recently, an aggregator aggregates adjustment quantities of power supply-demand provided by multiple consumers and aggregated adjustment quantities are then traded in the market. The adjustment quantities include a power suppression amount, for example. Incentives or penalties gained from the market as a result of trading from power suppression are not an individual power suppression amount in each of the consumers but are determined by the aggregated power suppression amount.

Profit and loss of a consumer from among multiple consumers depend on the power suppression amount of the other consumers providing unused power. For this reason, cancellation of the power suppression by one consumer may cause a problem on the other consumers who provide the unused power.

To address this drawback, a power supply-demand control method is provided in a first aspect of the disclosure. The power supply-demand control method is related to a power supply-demand control method of a power supply-demand control system configured to adjust power supply-demand between a consumer and a power system by controlling electric equipment via a communication network during a supply-demand adjustment period. The power supply-demand control method includes receiving a request for changing the operation mode to a second operation mode higher in power consumption of the electric equipment than a first operation mode when the electric equipment operate in the first operation mode, in which power consumption of the consumer is suppressed, during the supply-demand adjustment period, and determining whether to permit the operation mode to change from the first operation mode to the second operation mode if a request for changing the operation mode to the second operation mode is received.

Whether to cancel the power suppression or not is thus appropriately selectable in response to a cancellation request of power suppression by a consumer during the power supply-demand adjustment period throughout which power supply-demand is adjusted. According to a second aspect of the disclosure, in view of the first aspect, the power supply-demand control method may further include suppressing power consumption of the consumer below a power consumption level prior to a start of the supply-demand adjustment period by starting the supply-demand adjustment period and changing an operation mode of the electric equipment in operation to a first operation mode in response to reception of a reduction request requesting the consumer to reduce power consumption. With this, power consumption of the consumer is suppressed.

According to a third aspect of the disclosure, in view of the second aspect, the power supply-demand control method may further include causing the electric equipment to continuously operate in the first operation mode without changing from the first operation mode to the second operation mode if changing to the second operation mode is determined not to be permitted.

If it is thus determined that the changing to the second operation mode is not permitted, the electric equipment operates in the first operation mode. Inconvenience that could occur in response to the changing to the second mode is thus reduced.

The inconvenience involved in the changing to the second operation mode, for example, is that a penalty caused by the fact that an aggregator has failed to provide a contracted power suppression service is imposed on the aggregator.

More specifically, the cancellation of the power suppression by a consumer causes a predetermined supply-demand adjustment quantity (a predetermined power suppression amount) to be unachievable. As a result, the same penalty may be imposed on all other consumers as on the aggregator or the incentive may be decreased. The term “cancellation of the power suppression” does not only mean a case where the power suppression is fully cancelled. The term includes a case where the power suppression is partially cancelled. The term used in the following description is similarly defined.

According to a fourth aspect of the disclosure, in view of the second aspect, the power supply-demand control method may further include determining whether a predetermined supply-demand adjustment quantity is achievable during the supply-demand adjustment period in case of changing the operation mode of the electric equipment from the first operation mode to the second operation mode in response to the request for changing, changing the operation mode of the electric equipment from the first operation mode to the second operation if the predetermined supply-demand adjustment quantity is determined to be achievable with the operation mode changed to the second operation mode, and causing the electric equipment to continuously operate in the first operation mode without changing the operation mode of the electric mode if the predetermined supply-demand adjustment quantity is determined not to be achievable with the operation mode changed to the second operation mode.

If the request for changing the operation mode from the first operation mode to the second operation mode is received during the supply-demand adjustment period, it is determined whether the predetermined supply-demand adjustment quantity (the predetermined power suppression amount) is achieved or not with the operation mode of the electric equipment changed from the first operation mode to the second operation mode. If it is determined that the predetermined supply-demand adjustment quantity is achieved, the operation mode is changed to the second operation mode. Even if the request for changing the operation mode from the first operation mode to the second operation mode is received during the supply-demand adjustment period, it is determined whether the predetermined supply-demand adjustment quantity is achieved. Thus, if the electric equipment operates in the second operation mode, the predetermined supply-demand adjustment quantity is still achieved. This avoids nonfulfillment of the contents of the contract. According to a fourth aspect of the disclosure, in view of any one of the first through the third aspects, the power supply-demand control method may further include permitting the change to the second mode when an increased amount of power consumption of the consumer accompanied by the change to the second mode is a first increased amount, and prohibiting the change to the second mode when the increased amount of power consumption of the consumer when the increased amount of power consumption of the consumer accompanied by the change to the second mode is a second increased amount higher than the first increased amount. With this, inconvenience that could occur in response to the changing to the second mode is reduced. According to a fifth aspect of the disclosure, in view of any one of the first through the third aspects, the power supply-demand control method may further including permitting the change to the second mode when power consumption of the consumer is first power consumption in reception of a changing request, and prohibiting the change to the second mode when the increased amount of power consumption of the consumer when power consumption of the consumer is second power consumption higher than first power consumption in reception of the changing request. With this, inconvenience that could occur in response to the changing to the second mode is reduced.

According to a seventh aspect of the disclosure, in view of the second aspect, the power supply-demand control method may further include causing a display, in response to reception of a changing request to the second operation mode, to display image data indicating the supply-demand adjustment period and image data that is used to cause a user as the consumer to confirm whether or not changing to the second operation mode is acceptable, and controlling the electric equipment in accordance with an user's answer as to whether or not changing to the second operation mode is acceptable after the image data is displayed on the display.

A control operation the user intends is thus performed.

According to a eighth aspect of the disclosure, in view of the seventh aspect, the power supply-demand control method may further include determining whether to permit the operation mode to change from the first operation mode to the second operation mode in response to reception of the user's answer instructing the operation mode to change to the second operation mode, and causing the display to display image data indicating that changing to the second operation mode is not permitted if the changing to the second operation mode is determined not to be permitted.

The user may thus learn that the changing to the second operation mode is difficult.

According to a ninth aspect of the disclosure, in view of one of the seventh and eighth aspects, the power supply-demand control method may further include causing the electric equipment to continuously operate in the first operation mode without changing from the first operation mode to the second operation mode if the answer that the user intends to cancel the changing to the second operation mode are received after the image data is displayed on the display.

According to a tenth aspect, in view of the seventh aspect, the power supply-demand control method may further include displaying, on the display, image data indicating incentive information about an incentive the consumer is offered by changing the operation mode of the electric equipment from the first operation mode to the second operation mode.

The user may learn the incentive that might be lost as a result of changing to the second operation mode, and the user may determine whether to change to the second operation mode in view of the incentive the user could gain.

According to an eleventh aspect of the disclosure, in view of the seventh aspect, the power supply-demand control method may further include displaying, on the display, multiple options indicative of correspondences between an index indicating a power suppression amount to be canceled and an index indicating a change in the incentive responsive to the power suppression amount to be canceled, and controlling the electric equipment in accordance with a selected option.

Control of the electric equipment more convenient for the user may selected.

According to a twelfth aspect of the disclosure, in view of any one of the first, the third and the forth aspects, the power supply-demand control method may further include changing the operation mode of the electric equipment from the first operation mode to a third operation mode in which power consumption of the electric equipment is higher than in the first operation mode and lower than in the second operation mode, if the changing to the second operation mode is determined not to be permitted.

Even if the changing to the second operation mode is difficult because of any problem, the problem may be mitigated, and the electric equipment may be operated in the third operation mode that is satisfying to a user request to increase power consumption of the electric equipment. For example, the user may modify a configuration temperature of an air conditioner to 25° C. in the second operation mode when the air conditioner operates at 28° C. in the first operation mode. If the air conditioner is changed to the second operation mode, the predetermined power suppression amount is not achieved. If the changing is not permitted with the air conditioner continuously operating at 28° C., comfort of the user may be decreased. In accordance with the ninth aspect, the third operation mode is offered to the user. For example, 27° C. is offered as the configuration temperature that still results in the predetermined power suppression amount and a determination as to whether to change the operation mode is left to the user. This leads to an increase in the degree of comfort.

According to a thirteenth aspect of the disclosure, in view of the first aspect, the power supply-demand control method may further include adjusting the power supply-demand between the power system and multiple consumers, determining whether power suppression in a first consumer is cancelable in view of total power consumption of the multiple consumers with the power suppression to the first consumer canceled if a first cancellation request to cancel the power suppression to the first consumer from among the multiple consumers is received, and canceling the power suppression to the first consumer if the power suppression to the first consumer is determined to be cancelable.

A determination as to whether to cancel the power suppression in the first consumer is performed with reference to the total power consumption of the other consumers. More specifically, the power compression amount of the other consumers is accounted for. Whether to cancel the power suppression is determined by accounting for the effect of the cancellation of the power compression to the first consumer on the other consumers (such as if a penalty is imposed or not).

According to an fourteenth aspect of the disclosure, in view of the thirteenth aspect, the power supply-demand control method may further include determining first permitted power to the first consumer so that the total power consumption is equal to or below a predetermined reference value, if the power suppression to the first consumer is determined to be cancelable, and controlling power consumption of the first consumer to be equal to or below the first permitted power.

If the first consumer consumes power limitlessly as a result of cancellation of the power suppression, there is a possibility that the other consumers are adversely affected (for example, a penalty is imposed on the other consumers). Since an upper limit is set on the power consumption of the first consumer in this way, the adverse effect on the other consumers is reduced.

According to a fifteenth aspect of the disclosure, in view of the fourteenth aspect, the power supply-demand control method may further include calculating a degree of comfort indicating comfort of the consumer in the operation mode of the electric equipment, and determining the first permitted power to be lower as the calculated degree of comfort becomes higher.

The permitted power is determined in view of comfort. If the user already enjoys a high degree of comfort, permitted power is configured to be lower regardless of the cancellation request of the power suppression. According to a sixteenth aspect of the disclosure, in view of the thirteenth aspect, the power supply-demand control method may further include determining whether power suppression to a second consumer is cancelable in view of total power consumption of the plurality of consumers with the power suppression to the second consumer canceled if a second cancellation request to cancel the power suppression to the second consumer from among the plurality of consumers is received after canceling the power suppression to the first consumer, and changing operation mode of the electric equipment of the first consumer from the second operation mode to a third operation mode in which power consumption of the electric equipment is higher than in the first operation mode and lower than in the second operation mode if the power suppression to the second consumer is determined to be uncancelable. With this, the power suppression of the second consumer may be canceled even if the power suppression to the second consumer is determined to be uncancelable.

According to a seventeenth aspect of the disclosure, a power supply-demand control apparatus, of a power supply-demand control system configured to adjust power supply-demand between a consumer and a power system by controlling electric equipment via a communication network during a supply-demand adjustment period, includes a receiver which receives a request for changing the operation mode to a second operation mode higher in power consumption of the electric equipment than a first operation mode when the electric equipment operate in the first operation mode, in which power consumption of the consumer is suppressed, during the supply-demand adjustment period, and a controller which determines whether to permit the operation mode to change from the first operation mode to the second operation mode if a request for changing the operation mode to the second operation mode is received.

During the power supply-demand adjustment period throughout which the power supply and demand are adjusted, whether to cancel the power suppression is determined in response to the cancellation request of the power suppression from the consumer.

According to a eighteenth aspect of the disclosure, in view of the first aspect, the power supply-demand control method may further include suppressing power consumption from a first reference value by at least a target amount of suppression by controlling the electric equipment in the first operation mode, determining whether to change from the first operation mode to the second operation mode in response to reception of the request for changing during the power supply-demand adjustment period, permitting the electric equipment to change from the first operation mode to the second operation mode if the target amount of suppression is determined to be achievable in the second operation mode during the power supply-demand adjustment period, and causing the electric equipment to operate in the second operation mode.

The first reference value may be dependent on the power consumption of the consumer prior to the power supply-demand adjustment period.

According to a nineteenth aspect of the disclosure, in view of any one of the first through fourteenth aspects, the request for changing from the first operation mode to the second operation mode is a cancellation request of the power suppression to the consumer.

According to a 20th aspect of the disclosure, in view of the eighteenth aspect, the power supply-demand control method may further include determining whether the power suppression to the consumer is cancelable by comparing a second reference value resulting from subtracting the target amount of suppression from the first reference value with the power consumption of the consumer with the power suppression canceled if the cancellation request of the power suppression to the consumer is received as the request for changing during the power supply-demand adjustment period, and canceling the power suppression to the consumer by causing the electric equipment to operate in the second operation mode if the power suppression to the consumer is determined to be cancelable.

According to a 21th aspect of the disclosure, in view of the 20th aspect, the power supply-demand control method may further include determining that the power suppression to the consumer is cancelable if the power consumption of the consumer with the power suppression to the consumer canceled is equal to or below the second reference value, and determining that the power suppression to the consumer is not cancelable if the power consumption of the consumer with the power suppression to the consumer canceled is above the second reference value.

Even if the cancellation request of the power suppression is received during the power supply-demand adjustment period, whether the power suppression is cancelable or not is determined by comparing the second reference value with the power consumption of the consumer with the power suppression canceled. For this reason, if the power suppression is canceled during the power supply-demand adjustment period, at least the target amount of suppression is achieved during the power supply-demand adjustment period.

According to an 22th aspect of the disclosure, in view of any one of the 19th through 21th aspects, the power supply-demand control method may further include determining permitted power equal to or below the second reference value if the cancellation of the power suppression to the consumer is determined to be cancelable, and controlling the power consumption of the consumer to the determined permitted power or lower.

The power consumption of the consumer may be controlled to within a suppression cancellation range having the permitted power as an upper limit thereof.

To cancel the power suppression, the permitted power at the upper limit where the target amount of suppression is achieved is freshly set again. In this way, not only the whole power suppression amount but also part of the power suppression amount is cancelable. Comfort to the consumer is thus maintained while the target amount of suppression is achieved.

According to a 23th aspect of the disclosure, in view of the third aspect, the power supply-demand control method may further include not canceling the power suppression to the consumer if the request for changing is a cancellation request to cancel the power suppression to the consumer, and the cancellation of the power suppression to the consumer is determined to be difficult.

If it is determined that the cancellation of the power suppression is difficult, the power suppression is not canceled. Imposing a penalty is thus avoided.

According to a 24th aspect of the disclosure, in view of the 13th aspect, the power supply-demand control method may further include determining whether the power suppression to the first consumer is cancelable by comparing the second reference value that results from subtracting from the first reference value the target amount of suppression of the power suppression during the power supply-demand adjustment period with the total power consumption of the multiple consumers with the power suppression to the first consumer canceled, if the request for changing is the cancellation of the power suppression to the consumer.

A determination as to whether the power suppression to the first consumer is cancelable is performed by comparing the total power consumption of the other consumers with the second reference value. More specifically, since the power suppression amount of the other consumers are taken into consideration, an adverse effect on the other consumers (such as a penalty) is avoided if the power suppression to the consumer is canceled.

According to a 25th aspect of the disclosure, in view of the 14th aspect, the request for changing is a cancellation request requesting the power suppression to the consumer to be canceled, and the predetermined reference value is the second reference value that results from subtracting the target amount of suppression from the first reference value.

The first reference value may be a value based on the power consumption of the consumer prior to the power supply-demand adjustment period. The power consumption of the consumer may be controlled within a first suppression cancellation range having first permitted power as an upper limit thereof.

To cancel the power suppression, the permitted power as the upper limit at which the target amount of suppression is achieved is freshly set again. In this way, not only the whole power suppression amount but also part of the power suppression amount is cancelable. Comfort to the consumer is thus maintained as much as possible while the target amount of suppression is achieved.

According to a 26th aspect of the disclosure, in view of the 25th aspect, the power supply-demand control method may further include determining, as the first permitted power, the power consumption of the multiple consumers with all the power suppression to the first consumer canceled if the first cancellation request is received, and if the total amount of the power suppression to the consumers other than the first consumer from among the multiple consumers is higher than the target amount of suppression.

According to a 27th aspect of the disclosure, in view of any one of the 25th and 25th aspects, the power supply-demand control method may further include determining the first permitted power so that the power suppression amount to the first consumer is equal to or above a difference that results from subtracting the total amount of the power suppression of the other consumers from the target amount of suppression if the first cancellation request is received, and if the total amount of the power suppression to the consumers other than the first consumer from among the multiple consumers is not higher than the target amount of suppression.

According to a 28th aspect of the disclosure, in view of any one of the 25th through 26th aspects, the power supply-demand control method may further include determining whether the power suppression to a second consumer is further cancelable if a second cancellation request to cancel the power suppression to the second consumer among the other consumers is received after starting to control the power consumption of the first consumer to equal to or below the first permitted power, determining second permitted power to the second consumer so that the total power consumption is equal to or below the second reference value if the target amount of suppression is determined to be achievable during the power supply-demand adjustment period with the power suppression to the second consumer canceled and if the power suppression to the second consumer is determined to be cancelable, and controlling the power consumption of the second consumer to be equal to or below the second permitted power.

A determination as to whether the target amount of suppression is achievable may be performed by comparing the second reference value with the total power consumption of the multiple consumers with the power suppression to the second consumer further canceled. The power consumption of the second consumer may be controlled to within a second suppression cancellation range having the second permitted power as an upper limit thereof.

According to the 28th aspect, if the cancellation request of the power suppression to the second consumer is made even after the first consumer makes the cancellation request of the power suppression, the power suppression to the second consumer may be adjusted to be canceled.

According to a 29th aspect of the disclosure, in view of the 28th aspect, the power supply-demand control method may further include updating the first permitted power to third permitted power lower in power consumption than the first permitted power if the target amount of suppression is determined to be unachievable with the power suppression to the second consumer canceled during the power supply-demand adjustment period, and if the power suppression to the second consumer is determined to be uncancelable, and controlling the power consumption of the first consumer to be equal to or below the third permitted power.

The power consumption of the first consumer may be controlled to within a third suppression cancellation range having the third permitted power as an upper limit thereof.

According to a 30th aspect of the disclosure, in view of the 29th aspect, the power supply-demand control method may further include determining the third permitted power so that the total power consumption with the power suppression to the second consumer canceled is equal to or below the second reference value.

If the cancellation request of the power suppression to the second consumer is made even after the first consumer makes the cancellation request of the power suppression, the power suppression to the second consumer may be adjusted to be canceled.

According to a 31th aspect of the disclosure, in view of any one of the 29th and 29th aspects, the power supply-demand control method may further include controlling the power consumption of the second consumer to be equal to or below the third permitted power.

The power consumption of the second consumer may be controlled to within the third suppression cancellation range having the third permitted power as an upper limit thereof.

Even if the first and second consumers make the cancellation request of the power suppression at different timings, the first and second consumers may resume equal permitted power. Cancellation control of the power suppression is thus fairly performed.

According to a 32th aspect of the disclosure, in view of one of 19th through 30th aspects, the power supply-demand control method may further include notifying the consumer that the power suppression is uncancelable if the power suppression to the consumer is determined to be uncancelable.

Even if the consumer makes the cancellation request of the power suppression, the power suppression may be determined to be uncancelable. The consumer is then notified that the power suppression is uncancelable. In the notification, the consumer may be further notified that a penalty is imposed if the power suppression is canceled.

The general and specific aspects may be implemented using a system, a method, an integrated circuit, a computer program, or a computer readable recording medium, such as CD-ROM, and the system, the method, the integrated circuit, the computer program, and the computer readable recording medium may be used in any combination.

A power supply-demand control method and a power supply-demand control system, of an embodiment of the disclosure, are specifically described with reference to the drawings.

The embodiment described below is a specific example of the disclosure. Values, shapes, materials, elements, mounting locations, connection form, steps, and order of steps are described for exemplary purposes only, and are not intended to limit the disclosure. Among the elements in the embodiment, elements not described in the independent claims indicative of higher concepts may be any arbitrary element.

In each embodiment below, a peak cut feature is described as an example of a demand response. The disclosure is not limited to the peak cut feature.

### First Embodiment

In a first embodiment, a power supply-demand control system and a power supply-demand control method for suppressing consumption power of a consumer by a predetermined portion of power during a predetermined period are described below.

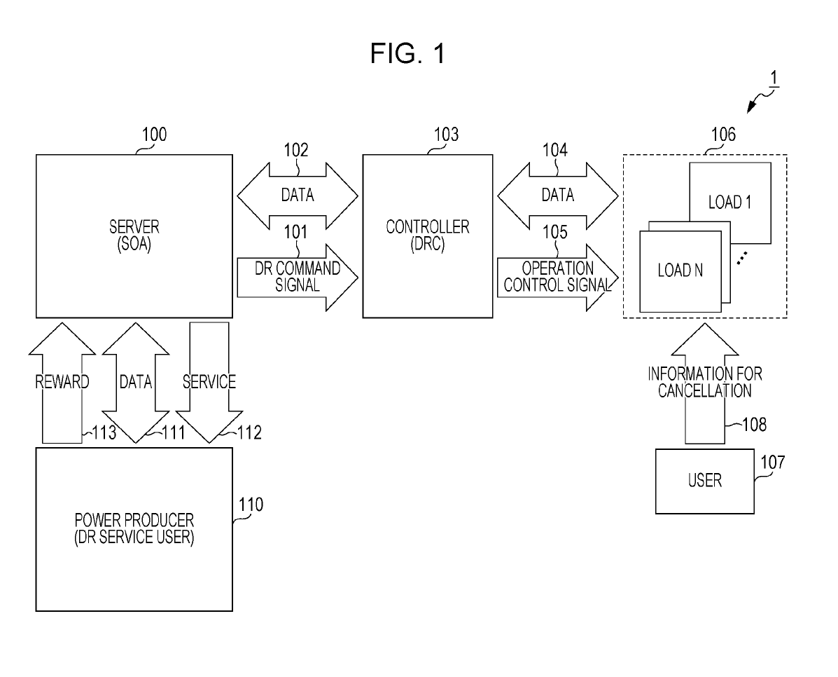

FIG. 1 illustrates a configuration of the power supply-demand control system 1 and a flow of information in the configuration of the first embodiment.

The power supply-demand control system 1 includes a server (server of aggregator (SOA)) 100, a power producer (DR service user) 110, a (demand response controller (DRC)) controller 103, and multiple loads 106. DR here stands for demand response.

The power producer 110 supplies data 111 to the server 100. For example, the data 111 includes a DR amount and a condition of permissible DR, such as an incentive and a penalty. The server 100 supplies to the power producer 110 the data 111 (such as DR bidding, DR index, and audit data). The server 100 supplies a service 112 (such as a predetermined DR operation) to the power producer 110, and receives a reward 113 from the power producer 110 in accordance with the data 111 and the service 112 supplied to at least the power producer 110.

The controller 103 controls the power consumption of the load 106. Upon receiving a DR command signal 101 from the server 100, the controller 103 transmits a operation control signal 105 to the load 106 to suppress the power consumption of the load 106. For example, if the load 106 is a cooling function of an air conditioner, the controller 103 controls the load 106 to increase the temperature of the air conditioner or to stop the air conditioner. The controller 103 exchanges, with the server 100, data 102 including contract information, power suppression portfolio, a risk of nonfulfillment, and a rule of cancellation (as described in detail below). The controller 103 further exchanges, with the load 106, data 104 including a target ID, load data, a cancellation request of the power suppression, context data of load, and a degree of comfort. The term “cancellation of the power suppression” does not only mean a case where the power suppression is fully cancelled. The term includes a case where the power suppression is partially cancelled. The term used in the following description is similarly defined.

The user 107 enters, to the load 106, cancellation information 108 indicative of the cancellation request of the power suppression. The user 107 is an example of the consumer.

The power producer 110 supplies a rule of permissible DR operation.

The power producer 110 may have the function of the server 100. The server 100 may have the function of the controller 103. Alternatively, the controller 103 may have the function of the server 100.

The power producer 110 determines incentive information indicating an incentive, penalty information indicating a penalty, agreed DR bidding, and a needed DR amount so that no penalty is imposed. The power producer 110 also determines DR starting time information indicating DR stating time and DR ending time information indicating DR ending time. These pieces of information are transmitted from the power producer 110 to the server 100 as data 111.

The sequence and package of the data 111 transmitted between the server 100 and the power producer 110 may be different, and may be transmitted via communication media, including the Internet, radio wave, telephone network, and voice/video/text message.

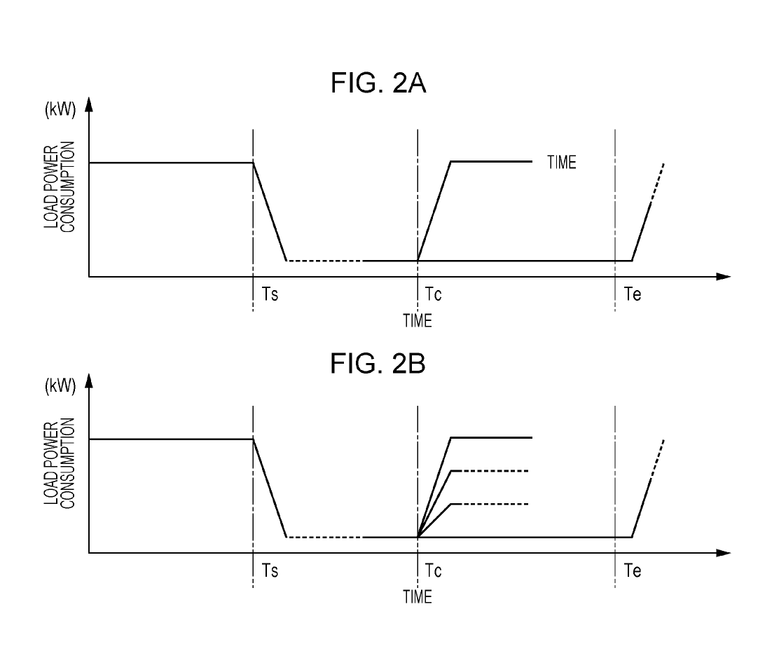

FIG. 2 illustrates a change in the power consumption of the load when the power consumption of the load resumes a state prior to the power suppression period in response to the cancellation of power suppression during the power suppression period. As illustrated in FIG. 2A, the power suppression starts time at Ts subsequent to a reduction in the power consumption of the load (hereinafter referred to as a “power suppression starting time Ts”) in accordance with a schedule of the power suppression. Once the power suppression starts, power is suppressed by a target amount of suppression ΔPt from a first reference value Pb1 based on the power consumption in the consumer prior to the power supply-demand adjustment period (namely, during a period prior to the power suppression starting time Ts). The power suppression, having started at the power suppression starting time Ts, is completed at time Te (hereinafter referred to as the power suppression ending time Te) after a predetermined period of time from the power suppression starting time Ts. The power suppression period is one type of the power supply-demand adjustment period throughout which the power supply and demand are adjusted.

There are times when the power suppression performed during the power suppression period ends prior to the power suppression ending time Te (in other words, the power suppression is canceled). In such a case, the user enters the cancellation request of the power suppression to the load 106, and the power suppression is canceled at time Tc (hereinafter referred to as a “power suppression cancellation time Tc”) between the power suppression starting time Ts and the power suppression ending time Te.

FIG. 2A illustrates a change in the power consumption of the load when the power suppression is canceled during the power suppression period in a power supply-demand control system of the related art. FIG. 2B illustrates a change in the power consumption of the load when the power suppression is canceled during the power suppression period in the power supply-demand control system 1 of the first embodiment.

As illustrated in FIG. 2A, the resumed power consumption of the load is not controlled in the related art when the cancellation request of the power suppression is received. More specifically, in the related art technique, the power consumption of the load subsequent to the cancellation of the power suppression returns to the power consumption of the load prior to the power suppression period.

However, in some loads, the power consumption thereof is controlled by controlling an operation state thereof. More specifically, such loads include an air conditioner having a compressor with the power consumption thereof controllable, a light emitting diode (LED) in which power consumption is controlled by adjusting brightness, chargers in which a magnitude of a current flowing in a charging operation is controllable (including a charger for charging a battery in an automobile or a battery for home use).

If the load is electronic equipment with the power consumption thereof controllable in the power supply-demand control system 1 of the first embodiment as illustrated in FIG. 2B, the power consumption of the load may not necessarily be the power consumption of the load prior to the power suppression period when the cancellation request of the power suppression is received. For example, the power consumption of the load may return to a power consumption level that is higher than the power consumption during the power suppression, but lower than the power consumption prior to the power suppression. The power consumption of the load to be resumed in this case may be determined by the server 100 based on the risk of nonfulfillment 215 of DR portfolio. The power consumption of the load may not return to the power consumption of the load prior to the power suppression period depending on the content of the cancellation request of the power suppression. For example, the power consumption of the load may return to the power consumption of the load lower than the power consumption prior to the power suppression when the cancellation request of the power suppression is the request for the partial cancellation of the power suppression.

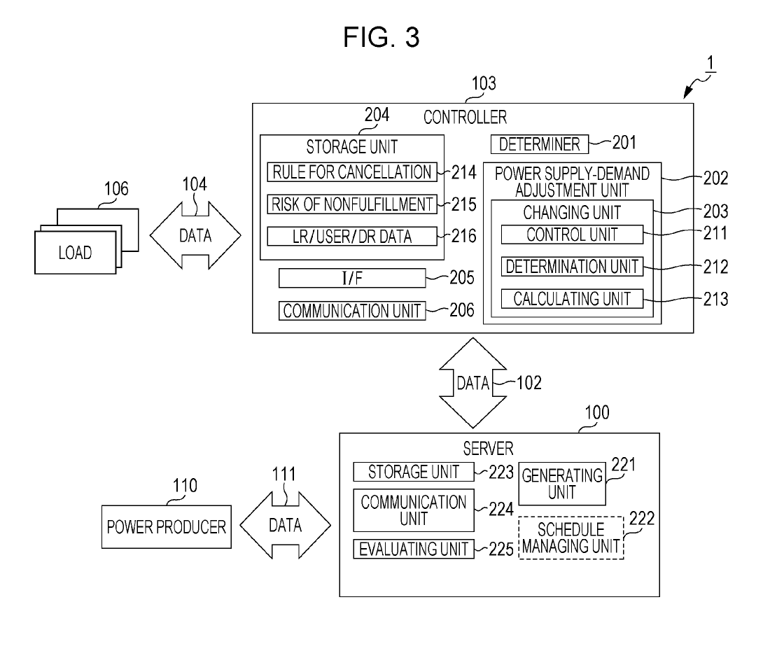

FIG. 3 is a block diagram illustrating the power supply-demand control system 1 of the first embodiment.

In the first embodiment, the power supply-demand control system 1 includes the server 100 and the controller 103 configured to control the power consumption of the load 106 as previously described.

### Server

The server 100 includes a generating unit 221, a schedule managing unit 222, a storage unit 223, a communication unit 224, and an evaluating unit 225.

The generating unit 221 generates the rule for cancellation 214 in accordance with the contract information stored on the storage unit 223.

The schedule managing unit 222 schedules the power suppression. More specifically, the schedule managing unit 222 reads the contract information from the storage unit 223. In accordance with the contract information, the schedule managing unit 222 transmits to the controller 103 via the communication unit 224, at the predetermined power suppression starting time Ts, a power suppression command to suppress the power consumption of the load 106 by a predetermined power suppression amount.

The storage unit 223 stores contract information of each consumer, cancellation information 108, and control information.

The contract information includes, in an associated state, a power suppression period determined based on a contract with the power producer 110, a power suppression amount to be suppressed by the load 106 at each consumer, a total amount of power suppression to be suppressed at the loads of multiple consumers (namely, the target amount of suppression), and criteria of a penalty to be imposed in the case of a failure to fulfill the contract.

The cancellation information 108 indicates the cancellation request of the power suppression to the consumer transmitted from the consumer. The cancellation information 108 indicates time of the cancellation of the power suppression, a power suppression amount serving as a target of the cancellation request out of the power suppression amount to the consumer, and a load serving as a target of the cancellation request of the power suppression out of the loads of the consumer. The time of the cancellation of the power suppression may be time at which the cancellation request of the power suppression has been made (more specifically, time with reference to the time of transmission of the cancellation information), or may be time specified by the consumer. The cancellation information is generated in response to the cancellation request of the power suppression (including a first cancellation information request) transmitted from the controller 103.

The control information indicates the power suppression amount of each of the multiple consumers, the total amount of power suppression of the multiple consumers, the period throughout which the power suppression is performed, and the time of the power suppression.

The communication unit 224 communicates information with the power producer 110 or the controller 103.

In accordance with each piece of information stored on the storage unit 223 or information received via the communication unit 224, the evaluating unit 225 calculates the risk of nonfulfillment 215 of a power suppression port folio based on power suppression contract information of each of the consumers. For example, the evaluating unit 225 calculates as the risk of nonfulfillment 215 a risk of a penalty that is incurred because of a failure to perform the power suppression defined in the contract in the consumers.

### Controller

The controller 103 includes a determiner 201, a power supply-demand adjustment unit 202, a changing unit 203, a storage unit 204, an interface (I/F) 205, and a communication unit 206. For convenience of explanation, the controller 103 is a singular number. If there are multiple consumers, each consumer is provided with the controller 103. In the case of multiple consumers, the power supply-demand control system 1 includes multiple controllers 103.

When the first cancellation request is received by the communication unit 206, the determiner 201 determines whether the power suppression to the first consumer is cancelable or not, by comparing the second reference value with interim total power consumption. The first cancellation request indicates a request to cancel the power suppression to the first consumer as one of multiple consumers during the power suppression period. The communication unit 206 functions as the receiver of this disclosure.

More specifically, when the first cancellation request is received during the power suppression period, the determiner 201 determines whether the target amount of suppression as a predetermined supply-demand adjustment quantity is achievable during the power suppression period with the operation mode of the electric equipment changed to the second operation mode in response to the first cancellation request. The first cancellation request is a request for changing the electric equipment in the operation mode from the first operation mode (an operation mode for the power suppression) to the second operation mode (a operation mode for cancelling the power suppression). The “second reference value” is a reference value that results from subtracting the target amount of suppression from the first reference value. The “interim total power consumption” is total power consumption of the multiple consumers based on the assumption that the power suppression to the first consumer has been canceled. The determiner 201 of the first consumer Interim total power consumption is calculated from the power consumption of the first consumer based on the assumption that the power suppression to the first consumer has been canceled and the power consumption of the other consumers. The controller 103 obtains the power consumption of the other consumers from the server 100 thorough the communication unit 224. If the interim total power consumption is equal to or below the second reference value, the determiner 201 determines that the power suppression to the first consumer is cancelable. If the interim total power consumption is above the second reference value, the determiner 201 determines that the power suppression to the first consumer is uncancelable. The determiner 201 may permit the change to the second mode when an increased amount of power consumption of the consumer accompanied by the change to the second mode is a first increased amount, and prohibit the change to the second mode when the increased amount of power consumption of the consumer when the increased amount of power consumption of the consumer accompanied by the change to the second mode is a second increased amount higher than the first increased amount. For example, the determiner 201 permits the change to the second mode if the user modifies the set temperature of the air conditioner to 27° C. in the second mode when the air conditioner operates at 28° C. in the first operation mode. On the other hand, the determiner 201 prohibits the change to the second mode if the user modifies the set temperature of the air conditioner to 25° C. in the second mode when the air conditioner operates at 28° C. in the first operation mode. This is due to the following reason. The canceled power suppression amount is relatively small and there is a high possibility to achieve the predetermined supply-demand adjustment quantity in a case where the set temperature of the air conditioner is modified to 27° C. However, the canceled power suppression amount is relatively large and there is a low possibility to achieve the predetermined supply-demand adjustment quantity in a case where the set temperature of the air conditioner is modified to 25° C. The determiner 201 may permit the change to the second mode when the power consumption of the consumer is first power consumption in reception of a changing request, and prohibit the change to the second mode when the power consumption of the consumer is second power consumption higher than first power consumption in reception of the changing request. For example, the determiner 201 permits the change to the second mode if the user modifies the set temperature of the air conditioner to 27° C. in the second mode when the air conditioner operates at 28° C. in the first operation mode and the power consumption of the user is 1.5 kW. On the other hand, the determiner 201 prohibits the change to the second mode if the user modifies the set temperature of the air conditioner to 27° C. in the second mode when the air conditioner operates at 28° C. in the first operation mode and the power consumption of the user is 2.0 kW. This is due to the following reason. The power consumption of the user is relatively small and there is a high possibility to achieve the predetermined supply-demand adjustment quantity in a case where the power consumption of the air conditioner is 1.5 kW in the reception of a cancellation request to cancel the power suppression. However, The power consumption of the user is relatively high and there is a low possibility to achieve the predetermined supply-demand adjustment quantity in a case where the power consumption of the air conditioner is 2.0 kW in the reception of the cancellation request to cancel the power suppression.

The power supply-demand adjustment unit 202 changes the power consumption by operating the electric equipment in the first operation mode during the power suppression period in response to the power suppression command from the communication unit 206. More specifically, the power supply-demand adjustment unit 202 controls the electric equipment to the first operation mode during the power suppression period, thereby suppressing the power consumption of the consumer from the first reference value based on the power consumption prior to the power suppression period by at least the target amount of suppression. More specifically, the power supply-demand adjustment unit 202 controls the electric equipment in response to the received adjustment request during the power supply-demand adjustment period, thereby achieving the predetermined supply-demand adjustment quantity during the power supply-demand adjustment period. The power supply-demand adjustment unit 202 includes the changing unit 203.

If the determiner 201 determines that the power suppression to the first consumer is cancelable, the changing unit 203 cancels the power suppression to the first consumer. If the determiner 201 determines that the power suppression to the first consumer is uncancelable, the changing unit 203 does not cancel the power suppression to the first consumer. More specifically, if the determiner 201 determines that the target amount of suppression is achievable during the power suppression period even with the operation mode of the electric equipment changed to the second operation mode, the changing unit 203 changes the operation mode of the electric equipment from the first operation mode to the second operation mode. The changing unit 203 includes a controller 211, a determination unit 212, and a calculating unit 213.

The controller 211 controls the power consumption of the load 106. More specifically, the controller 211 controls time of the power suppression and the power suppression amount to the load 106 in accordance with a schedule of predetermined power suppression. For example, the controller 211 controls the power consumption of the first consumer to within the first suppression cancellation range having as the upper limit thereof the first permitted power determined by the determination unit 212.

If the determiner 201 in the controller 103 determines that the power suppression to the first consumer is cancelable, the determination unit 212 determines the first permitted power to the first consumer so that the interim total power consumption is equal to or below the second reference value.

If the communication unit 206 in the controller 103 receives the first cancellation request and the total amount of power suppression to the consumers other than the first consumer among the multiple consumers is above the target amount of suppression, the determination unit 212 determines as the first permitted power the power consumption of the first consumer with all the power suppression to the first consumer canceled. In such a case, the target amount of suppression is achievable by the power suppression to all the other consumers without the need for the power suppression to the first consumer. The power consumption of the first consumer with all the power suppression to the first consumer canceled is thus determined as the first permitted power.

If the communication unit 224 in the server 100 receives the first cancellation request and the total amount of power suppression to the consumers other than the first consumer among the multiple consumers is not above the target amount of suppression, the determination unit 212 determines the first permitted power so that the power suppression amount to the first consumer is equal to or above a difference value between the target amount of suppression and the total amount of the power suppression of the other consumers. Since the power suppression to the other consumers alone does not cover the target amount of suppression, the first permitted power is determined so that the power suppression amount to the first consumer is configured to be equal to above the difference value. If the power suppression amount to the first consumer during the power suppression period is higher than the difference value, the first consumer simply suppresses the consumption power by the difference value. This means that part of the power suppression is cancelable. The first permitted power is determined to be equal to or lower than the value obtained by adding the power suppression amount canceled by the first cancellation request to the power consumption in the first operation mode.

The calculating unit 213 calculates a degree of comfort to the first consumer provided by the electric equipment as the load of the first consumer. The determination unit 212 may determine the first permitted power to be higher as the degree of comfort calculated by the calculating unit 213 is lower.

The storage unit 204 stores the rule for cancellation 214, the risk of nonfulfillment 215, and LR/user/DR data 216. The rule for cancellation 214 is a rule in accordance with the determination unit 212 determines, as the first permitted power, permitted power to the consumer as a target of the cancellation request of the power suppression. The risk of nonfulfillment 215 is a risk of the power suppression portfolio calculated by the evaluating unit 225 in the server 100 if the power suppression to the load 106 is canceled by the controller 103. The LR/user/DR data 216 includes context data of the load controlled by the controller 103, user data, and power suppression contract information.

An interface (I/F) 205 includes an input receiving unit configured to receive a cancellation command indicating the cancellation request of the power suppression, and a schedule of the power suppression from the consumer, a variety of sensors configured to acquire the degree of comfort to the consumer, and a display configured to display the value of each sensor or the context data of the load.

The communication unit 206 communicates with the load 106 and transmits a control signal to control the power suppression to the load 106. The communication unit 206 receives information transmitted from the load 106, including information of the current power consumption of the load 106 and the cancellation command indicating the cancellation request of the power suppression from the consumer. The communication unit 206 communicates with the server 100 and transmits the cancellation command received from the load 106 to the server 100, and receives a power control command transmitted from the server 100. In summary, the communication unit 206 receives an adjustment request as a signal requesting the adjustment of power supply and demand. The server 100 may comprise a part of the above-mentioned elements in the controller 103. For example, the sever 100 may comprise at least one of the determiner 201 and the storage unit 204.

### Power Supply-Demand Control Method

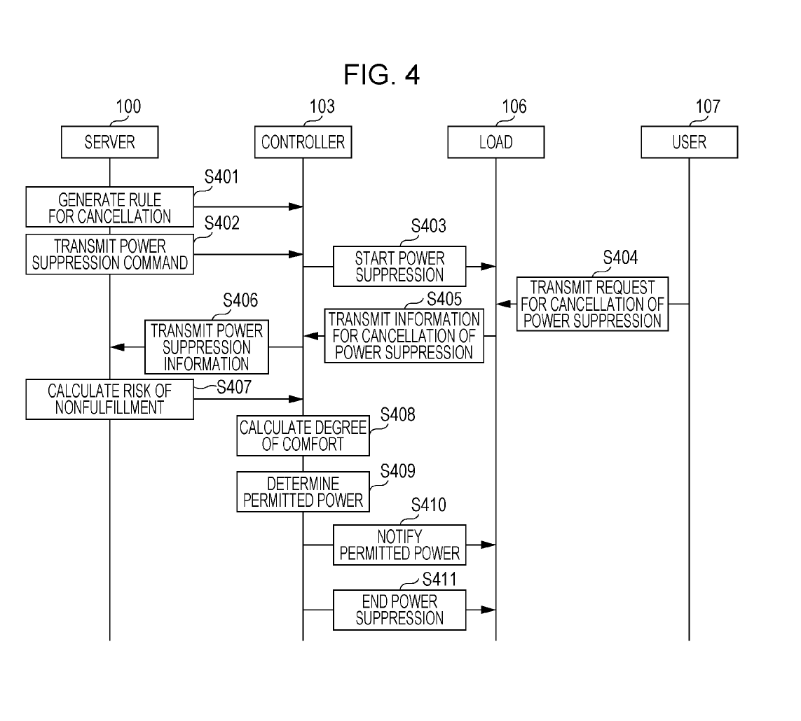

FIG. 4 is a flowchart illustrating a power supply-demand control method performed by the power supply-demand control system 1 of the first embodiment.

The server 100 generates the rule for cancellation 214 to determine a returning level (namely, the first permitted power) of the load 106 after the cancellation of the power suppression, and transmits the rule for cancellation 214 to the controller 103 (S401).

At predetermined power suppression starting time Ts, the schedule managing unit 222 in the server 100 transmits to the controller 103 via the communication unit 224 the power suppression command to suppress the power consumption of the load 106 by the predetermined power suppression amount, based on the power suppression contract information stored on the storage unit 223 (S402).

Upon receiving the power suppression command in step S402, the controller 103 starts the power suppression on the load 106 (S403). Once the power suppression starts, the controller 103 performs a control operation to reduce the power consumption on each load. More specifically, if an air conditioner as a load performs a cooling operation, the configuration temperature is controlled to be raised, or a compressor in the air conditioner is turned off (thermostat off control). If the load is an LED light, brightness of the LED light is controlled to a lower level. If the load is a charger, an amount of charging is controlled to reduction.

In a state that the power suppression is under way after starting in step S403 but has not yet completed (namely, during the power suppression period), a consumer may input a command indicating the cancellation request of the power suppression to the load 106 (S404). The command indicating cancellation request may be transmitted from a remote control to the load 106 when the consumer presses a predetermined button on the remote control to switch the operation mode of the load. An input device the consumer inputs the command is not limited to a remote control. The input device may be a smart phone, or a button arranged on a main body of the load 106.

The command indicating the cancellation request of the power suppression may be transmitted to the controller 103 rather than to the load 106. In such a case, a load serving as a target of the cancellation of the power suppression is specified. If the load serving as the target of the cancellation of the power suppression is not specified, the controller 103 may determine the load serving the target of the cancellation of the power suppression in accordance with a predetermined algorithm. If the load serving as the target of the cancellation of the power suppression is not specified, all loads of which power consumption is suppressed by the customer may be the target of the cancellation of the power suppression. If the server 100 comprises the determiner 201, the cancellation request of the power consumption may be transmitted to the server 103. The communication unit 224 functions as the receiver of this disclosure.

Upon receiving the command indicating the cancellation request of the power suppression in step S404, the load 106 transmits to the controller 103 the cancellation information of the power suppression indicating that the command indicating the cancellation request of the power suppression has been input (S405).

The controller 103 transmits to the server 100 the power suppression information indicating the power suppression amount on the load 106 during the power suppression period (S406). The power suppression information is sufficient if the power suppression amount is calculated therefrom. The power suppression information may thus be information indicating the power consumption of the load 106 prior to the power suppression period, and the power suppression of the load 106 during the power suppression period. This is because the power suppression amount is derived by calculating a difference between the power consumption of the load 106 prior to the power suppression period, and the power suppression of the load 106 during the power suppression period.

The evaluating unit 225 in the server 100 calculates the risk of nonfulfillment 215 based on the power suppression information received in step S406 and the contract information stored on the storage unit 223, and transmits the calculated risk of nonfulfillment 215 to the controller 103 (S407).

After the risk of nonfulfillment 215 is received, the calculating unit 213 in the controller 103 calculates the degree of comfort to the consumer having the load (S408). If the load is an air conditioner in step S408, the calculating unit 213 calculates the degree of comfort based on the indoor temperature and indoor humidity of a room where the air conditioner is installed. If the load is a light, the calculating unit 213 calculates the degree of comfort based on the brightness of the light. If the load is a charger for a battery, the calculating unit 213 calculates the degree of comfort based on a state of charge (SOC) of the battery. The calculating unit 213 may calculate the degree of comfort based on the assumption that the power suppression continues until the power suppression ending time Te. The calculating unit 213 may calculate the degree of comfort after the controller 103 has received the cancellation request of the power suppression from the load, rather than after receiving the risk of nonfulfillment 215.

The determiner 201 in the controller 103 determines whether the power suppression to the load as a target of the cancellation request of the power suppression is cancelable, in accordance with the rule of cancellation generated in step S401, the risk of nonfulfillment 215 calculated in step S407, and the degree of comfort calculated in step S408. The determiner 201 also determines the permitted power of the consumer (S409). The determiner 201 performs the determination operation to the target of the cancellation request of the power suppression in step S409. If the consumer has multiple loads, the controller 103 may perform the determination operation on all the loads of the consumer.

The determination unit 212 in the controller 103 determines the permitted power based on the permitted power determined in step S409, and the controller 211 controls the power consumption of the consumer to within the suppression cancellation range having as an upper limit thereof the permitted power determined by the determination unit 212 (S410).

If it is the power suppression ending time Te, the controller 211 in the controller 103 ends the power suppression (S411).

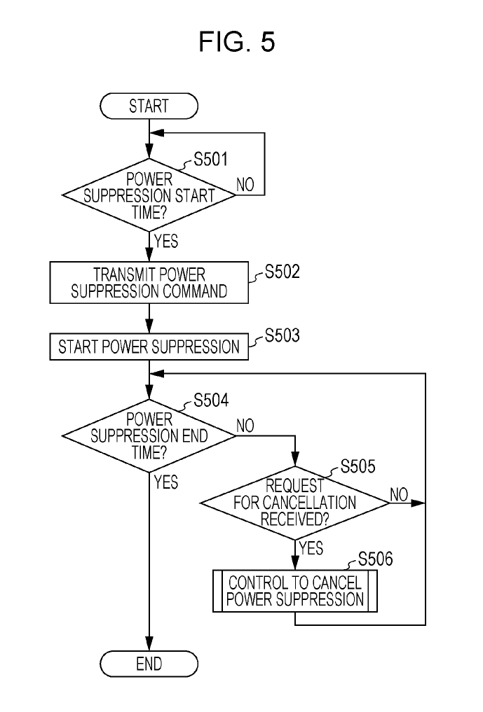

FIG. 5 is a flowchart illustrating the power supply-demand control method performed by the power supply-demand control system 1 of the first embodiment.

The server 100 determines whether it is the power suppression starting time Ts (S501). If the server 100 determines that it is the power suppression starting time Ts (yes branch from S501), the server 100 transmits the power suppression command to the controller 103 of each consumer (S502). On the other hand, if the server 100 determines that it not yet the power suppression starting time Ts (no branch from S501), the server 100 returns to step S501.

Upon receiving the power suppression command transmitted in step S502, the controller 103 starts the power suppression to each load 106 (S503). In other words, the controller 103 receives the power suppression command as an adjustment request, and causes the electric equipment to operate in the first operation mode. The controller 103 determines whether it is the power suppression ending time Te (S504). If the controller 103 determines that it is the power suppression ending time Te (yes branch from S504), the controller 103 ends the power suppression. If the controller 103 determines that it is not yet the power suppression ending time Te (no branch from S504), the controller 103 determines whether the load 106 of each consumer has received the cancellation request of the power suppression (S505). If the controller 103 determines that the cancellation request of the power suppression has been received (yes branch from S505), the controller 103 performs the cancellation control of the power suppression (S506). If the controller 103 determines that the cancellation control of the power suppression is to end, or the controller 103 determines in step S505 that the cancellation request has not been received, the controller 103 returns to step S504.

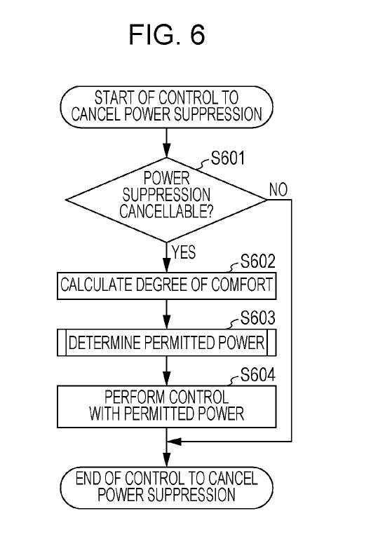

FIG. 6 is a flowchart illustrating the power cancellation control performed by the power supply-demand control system 1 of the first embodiment.

The determiner 201 in the controller 103 determines whether the power suppression is cancelable (S601). If the determiner 201 determines that the power suppression is cancelable (yes branch from S601), the changing unit 203 performs operations in steps S602 through S604 to cancel the power suppression. More specifically, the calculating unit 213 calculates the degree of comfort (S602). If the determiner 201 determines that the power suppression is not cancelable (no branch from S601), the cancel control of the power suppression is completed without canceling the power suppression. The determination unit 212 determines permitted power (S603). The controller 211 controls the load 106 to the determined permitted power (S604).

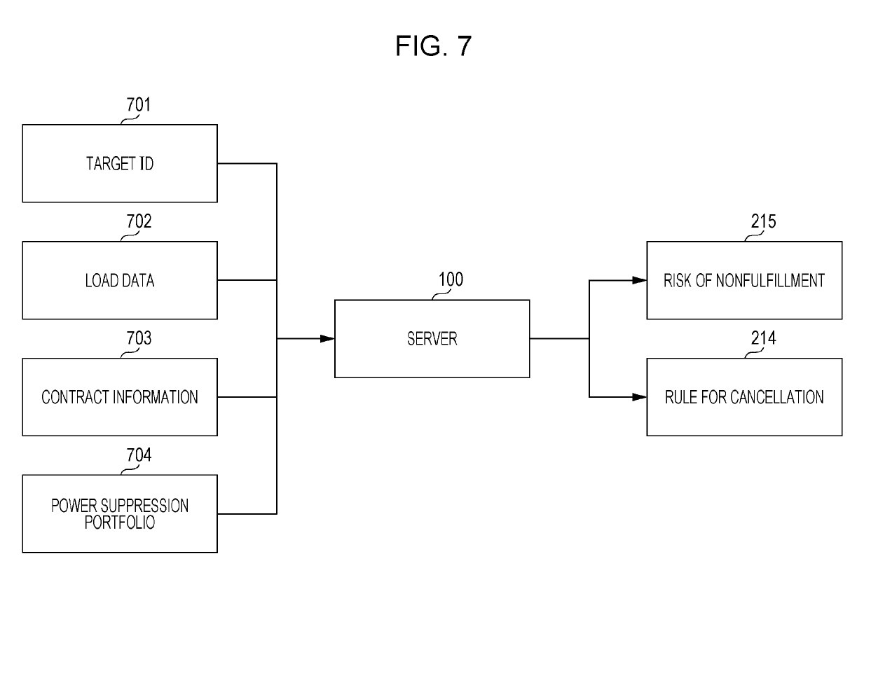

FIG. 7 illustrates information related to an input to and an output from the server 100 of the first embodiment.

Referring to FIG. 7, the server 100 retrieves a target ID 701, load data 702, contract information 703, and power suppression portfolio 704 via the communication unit 224 (or from the storage unit 223).

The target ID 701 is information that identifies the controller 103 and/or the load 106 that is a target of the cancellation request of the power suppression. The server 100 retrieves the target ID 701 from the load 106 or the controller 103. The target ID 701 is retrieved so that the server 100 analyzes the contract related to the power suppression of the consumer having the controller 103 and/or the load 106 that is the target of the cancellation request of the power suppression.

The load data 702 indicates the power suppression amount achieved by each of the multiple loads. More specifically, the load data 702 associates a load identification (ID) identifying a load of the multiple loads with a power suppression amount achieved by that load.

As described above, the contract information 703 is information that associates the power suppression period defined by the contract with the total amount of power suppression amount of the multiple consumers. More specifically, the contract information 703 includes a determination criterion according to which a determination as to whether the power suppression is fulfilled or not is performed, or a calculation standard on which a penalty for nonfulfillment is calculated.

The power suppression portfolio 704 includes portfolio data indicating the power suppression amount of each of the multiple consumers, and the power suppression amount actually achieved at the current point of time. More specifically, the power suppression portfolio 704 is information used to evaluate a margin at the current point of time. The margin is a quantity that results from subtracting the power suppression amount actually achieved by the server 100 (aggregator) from the target amount of suppression for the power suppression.

The server 100 calculates the risk of nonfulfillment 215 upon receiving the target ID 701, the load data 702, the contract information 703, and the power suppression portfolio 704. Upon receiving at least the contract information 703, the server 100 produces the rule for cancellation 214. The contract information 703 serves as a criterion as to how the risk of nonfulfillment 215 of the power suppression is determined, and as to how the risk of nonfulfillment 215 is treated by the power producer.

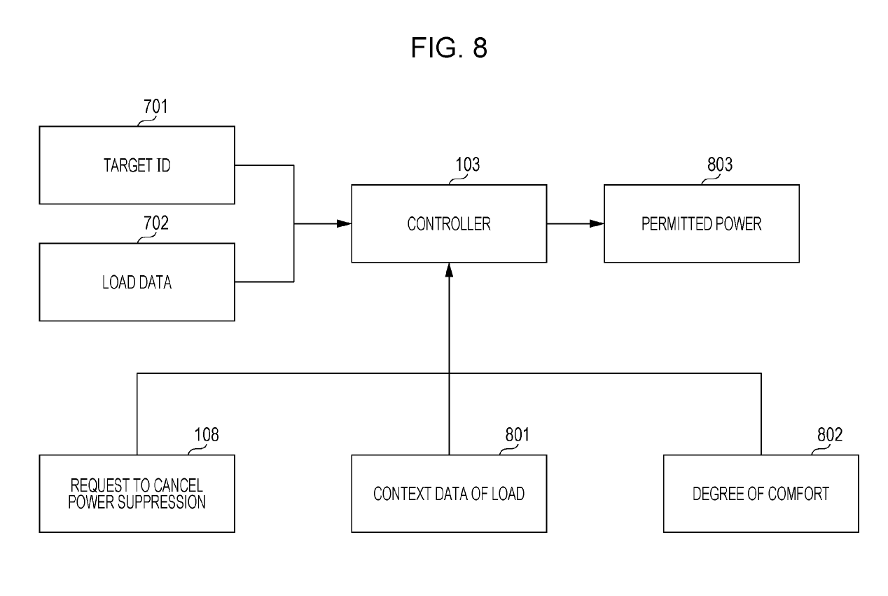

FIG. 8 illustrates information related to an input to and an output from the controller 103 of the first embodiment.

The controller 103 retrieves at least the following three pieces of information. The three pieces of information includes the rule for cancellation 214, the risk of nonfulfillment 215, and the cancellation request of the power suppression. The controller 103 also retrieves from each load 106 the context data 801 of the load 106, including the power consumption, SOC, and an energy consumption rate. The controller 103 calculates the degree of comfort 802 at each consumer. The degree of comfort 802 indicates how much the degree of comfort 802 of the consumer is affected by the power suppression of the consumer. Upon retrieving the cancellation information 108 of the power suppression from the consumer, the controller 103 determines the permitted power 803 subsequent to the cancellation of the power suppression to the consumer, based on the rule for cancellation 214, the risk of nonfulfillment 215, the context data 801 of the load 106, and the degree of comfort 802. To determine the permitted power 803 subsequent to the cancellation of the power suppression, the controller 103 may account for the contract with the aggregator of the consumers, and the degree of comfort 802 detected at the end of the power suppression.

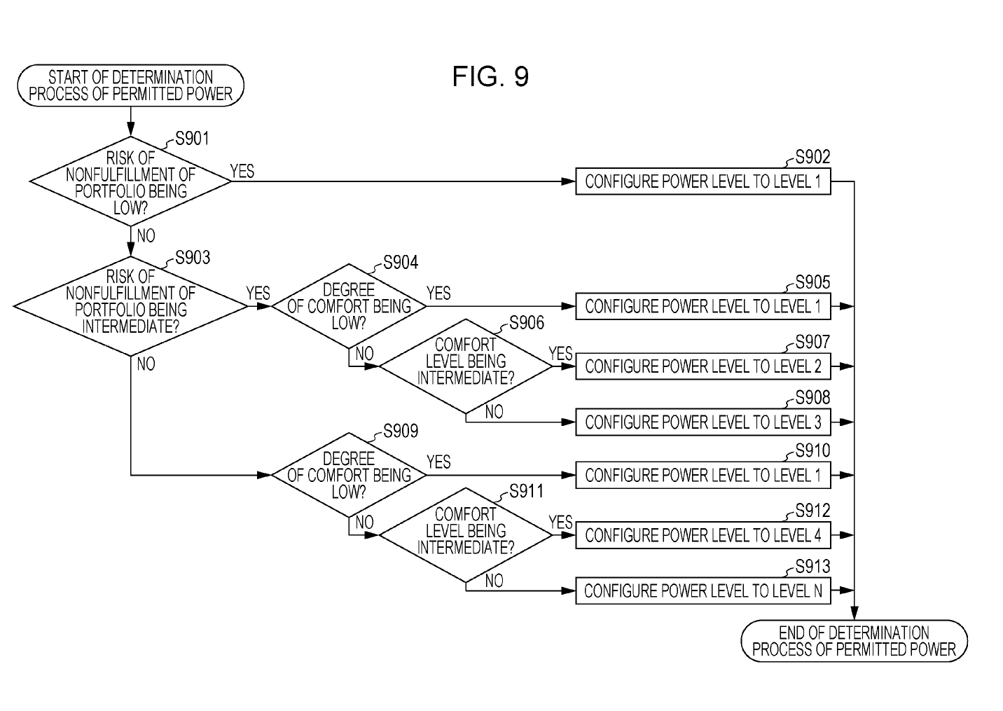

FIG. 9 is a flowchart illustrating of a determination process of the permitted power performed in accordance with the rule for cancellation 214. The determination unit 212 determines the permitted power 803 by applying to the rule for cancellation 214 the power suppression portfolio 704, the risk of nonfulfillment 215, the degree of comfort 802, and the context data 801 of the load.

The determination unit 212 determines whether the risk of nonfulfillment 215 of the portfolio is “low” (S901). The determination method of the risk of nonfulfillment 215 of the portfolio is described below. Upon determining that the risk of nonfulfillment 215 of the portfolio is “low” (yes branch from S901), the determination unit 212 configure the permitted power 803 to be at a level 1 that is a power level with all the power suppression of the consumer as a target of the cancellation request canceled (S902).

Upon determining that the risk of nonfulfillment 215 of the portfolio is not “low” (no branch from S901), the determination unit 212 determines whether the risk of nonfulfillment 215 of the portfolio is “intermediate” (S903). Upon determining that the risk of nonfulfillment 215 of the portfolio is “intermediate” (yes branch from S903), the determination unit 212 determines whether the degree of comfort 802 is “low” (S904). The determination method of the degree of comfort 802 is described below.

Upon determining that the degree of comfort 802 is “low” (yes branch from S904), the determination unit 212 configures the permitted power 803 to be at the level 1 (S905). Upon determining that the degree of comfort 802 is not “low” (no branch from S904), the determination unit 212 determines whether the degree of comfort 802 is “intermediate” (S906). Upon determining that the degree of comfort 802 is “intermediate” (yes branch from S906), the determination unit 212 configures the permitted power 803 to be at a level 2 that is lower in consumption level than the level 1 (S907). Upon determining that the degree of comfort 802 is not “intermediate” (no branch from S906) (namely, determining that the degree of comfort 802 is “high”), the determination unit 212 configures the permitted power 803 to be at a level 3 that is lower in consumption level than the level 2 (S908).

Upon determining that the risk of nonfulfillment 215 of the portfolio is not “intermediate” (namely, determining that the risk of nonfulfillment 215 of the portfolio is “high”) (no branch from S903), the determination unit 212 determines whether the degree of comfort 802 is “low” (S909). Upon determining that the degree of comfort 802 is “low” (yes branch from S909), the determination unit 212 configures the permitted power 803 to be at the level 1 (S910). Upon determining that the degree of comfort 802 is not “low” (no branch from S909), the determination unit 212 determines whether the degree of comfort 802 is “intermediate” (S911). Upon determining that the degree of comfort 802 is “intermediate” (yes branch from S911), the determination unit 212 configures the permitted power 803 to be at a level 4 lower than in consumption power than the level 3 (S912). Upon determining that the degree of comfort 802 is not “intermediate” (namely, determining that the degree of comfort 802 is “high”) (no branch from S911), the determination unit 212 configures the permitted power 803 to be at a level N equal to the power consumption during the power suppression (S913).

In the rule of cancellation, the permitted power 803 is determined in view of the degree of comfort 802. The permitted power 803 is thus determined so that the permitted power 803 is higher as the degree of comfort 802 is lower.

Permitted power of each of the level 1, the level 2, the level 3, and the level 4 is higher than the permitted power at the level N. More specifically, if the permitted power of one of the level 1, the level 2, the level 3, and the level 4 is determined, at least part of the power suppression amount of the power suppression is canceled. The power suppression is not canceled in the Level N. In other words, the power suppression may not be canceled even if it is determined that the power suppression can be canceled.

If an air conditioner as a load operates in a cooling operation, the degree of comfort 802 may be determined by the calculating unit 213 as described below. For example, the degree of comfort 802 is configured to be “high” if the indoor temperature detected by the air conditioner is 28° C. or lower, the degree of comfort 802 is configured to be “intermediate” if the indoor temperature is higher than 28° C. but equal to or lower than 30° C., and the degree of comfort 802 is configured to be “low” if the indoor temperature is higher than 30° C. If the load is a light, the degree of comfort 802 may be configured at multiple steps depending on brightness. If the load is a battery, the degree of comfort 802 may be configured depending on a charge amount. In this case, the permitted power 803 may be determined without accounting for the degree of comfort 802.

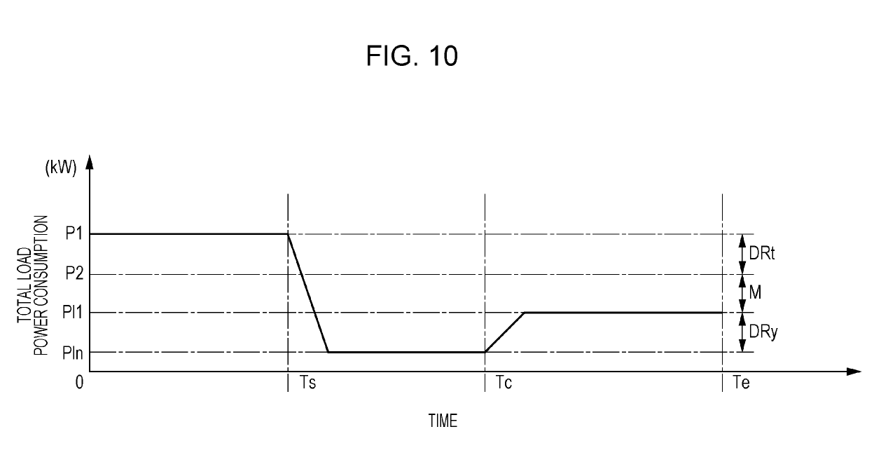

FIG. 10 illustrates power consumption in a load with the power suppression canceled and the concept of margin that is a difference between the first reference value and the second reference value that results from subtracting the target amount of suppression from the first reference value. FIG. 10 is intended to illustrate how the total amount of power consumption of loads at multiple consumers aggregated by the server 100 changes during the power suppression period.

The total amount DRt of power suppression indicated to the multiple consumers (the target amount of suppression) by the server 100 results from subtracting a second reference value P2 as the total power consumption permitted during the power suppression from a first reference value P1 as the total power consumption of the load prior to the power supply-demand adjustment period. The total amount DRt of power suppression is expressed by Formula (1):

DRt=P1−P2 (1)

The margin M with the power suppression of the first consumer from among the multiple consumers canceled is represented by a value that results from subtracting, from a second reference value P2, the total amount Pl1 of power consumption of the loads of the multiple consumers (namely, the interim total power consumption) with the power suppression to the load of the first consumer canceled. The margin M is represented Formula (2):

M=P2−Pl1 (2)

Let Pln represent the total power consumption of the loads of the multiple consumers prior to the cancellation of the power suppression and the power suppression amount DRy canceled is expressed by the following Formula (3):

DRy=Pl1−Pln (3)

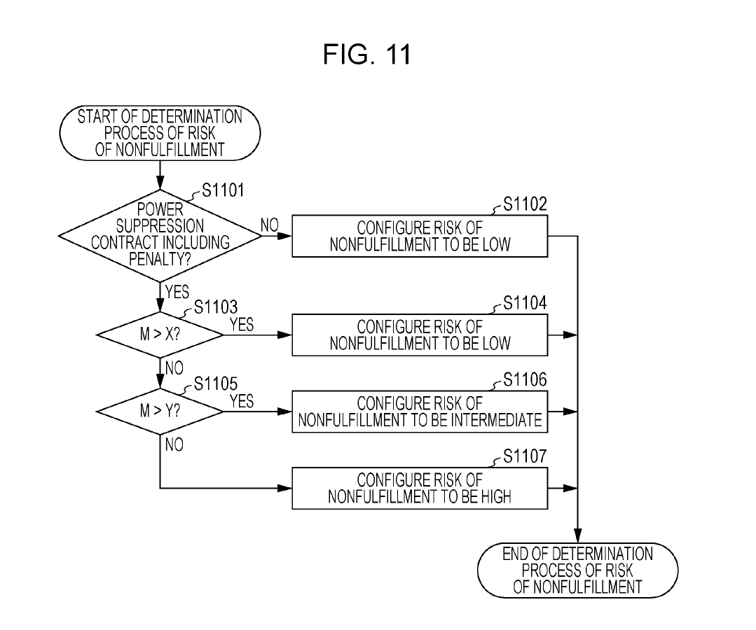

FIG. 11 is a flowchart illustrating an example of a determination method of the risk of nonfulfillment 215. The risk of nonfulfillment 215 is determined by the evaluating unit 225 in the server 100 as previously described.

The evaluating unit 225 references the contract information stored on the storage unit 223 to determine whether the contract between the aggregator and the power producer involves a penalty (S1101). If the contract involves no penalty (no branch from S1101), the evaluating unit 225 configures the risk of nonfulfillment 215 to be “low”. This is because any load level is permissible during the power control under such a contract. If the contract of the power control involves a penalty regardless of the type of the penalty, the evaluating unit 225 determines the risk of nonfulfillment 215 based on the margin M calculated in accordance with Formula (2).

Upon determining that the contract involves a penalty (yes branch from S1101), the evaluating unit 225 determines whether the margin M is higher than a predetermined threshold value X (S1103). Upon determining that the margin M is higher than the threshold value X (yes branch from S1103), the evaluating unit 225 configures the risk of nonfulfillment 215 to be “low” (S1104). Upon determining that the margin M is equal to or below the predetermined threshold value X (no branch from S1103), the evaluating unit 225 determines whether the margin M is higher than a predetermined threshold value Y (X>Y) (S1105). Upon determining that the margin M is higher than the predetermined threshold value Y (namely, X>M>Y) (yes branch from S1105), the evaluating unit 225 configures the risk of nonfulfillment 215 to be “intermediate” (S1106). On the other hand, upon determining that the margin M is equal to or lower than the predetermined threshold value Y (no branch from S1105), the evaluating unit 225 configures the risk of nonfulfillment 215 to be “high” (S1107).

### EXAMPLES

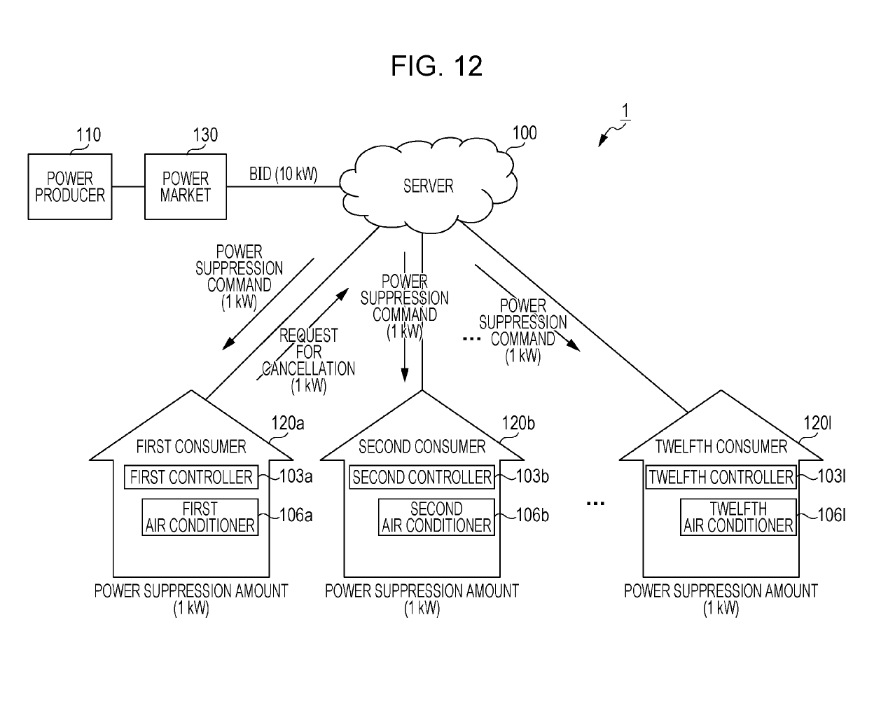

FIG. 12 illustrates a specific application example of the power supply-demand control system 1 of the first embodiment.

As illustrated in FIG. 12, the power producer 110 and the server 100 are linked in communication with each other through a network via a power market 130. The server 100 is linked in communication with each of controllers 103a through 103c of consumers 120a through 120c. Referring to FIG. 12, the power producer 110 is linked to the server 100 via the power market 130, but the power market 130 may not necessarily be present. More specifically, a power supply-demand control system may be constructed so that the power producer 110 and the server 100 directly trade power, not via the power market 130, as illustrated in FIG. 1.

The server 100 collects the power suppression amount (negawatt power) in each of the consumers 120a through 120l as illustrated in FIG. 12, and functions as an aggregator that trade power with the power producer 110 via the power market 130. Multiple consumers are the first consumer 120a, the second consumer 120b, the third consumer 120c, . . . , a twelfth consumer 120l. The number of consumers is 12 as illustrated in FIG. 12, but is not limited to 12. The server 100 may collect negawatt power from more than or less than 12 consumers. The number of consumers linked to the server 100 may not necessarily be multiple. The server 100 may be linked to a single consumer.

The first consumer 120a includes a first controller 103a, and a first air conditioner 106a. The second consumer 120b includes a second controller 103b and a second air conditioner 106b. Similarly, an n-th consumer 120x includes an n-th controller 103x and an n-th air conditioner 106x. Note that n is any natural number within a range of from 1 through 12, and x is an n-th alphabet (namely, a through 1). Each of the controllers 103a through 1031 of the consumers 120a through 120l is identical in configuration to the controller 103 of FIG. 1. Each of the first air conditioner 106a through the twelfth air conditioner 1061 is identical in configuration to the load 106 of FIG. 1.

During the power suppression, the server 100 functioning as an aggregator determines the power suppression amount of each of the consumers 120a through 120l in view of the past record of the power consumption of each of the consumers 120a through 120l, and trades power with the power market 130 to suppress power consumption by a predetermined power consumption amount (the target amount of suppression) during a predetermined time band (the power suppression period). For example, the server 100 may now make a contract to suppress a power of 10 kW during the power suppression period in FIG. 12. More specifically, the power producer 110 may make a bid for 10 kW with the server 100 via the power market 130 during the power suppression period. Based on the contents of the agreed contract, at the start of the power suppression period, the server 100 transmits a power suppression command of a power suppression amount of 1 kW to each of the first air conditioner 106a through the twelfth air conditioner 1061 of the consumers 120a through 120l. In the consumers 120a through 120l, the controllers 103a through 1031 respectively control the air conditioners 106a through 1061 to suppress the power consumption thereof by a predetermined power suppression amount (1 kW). The controllers 103a through 1031 respectively control the power consumption amounts of the air conditioners 106a through 1061 to within the power suppression range having the second reference value as an upper limit thereof. The second reference value results from subtracting, from the first reference value based on the power consumption in the consumer prior to the power suppression period, at least the power suppression amount specified in each power suppression command. The air conditioners 106a through 1061 are controlled in operation modes corresponding to four step-wise power consumption levels as described below.

In operation mode 1, the power consumption of the compressor of an air conditioner is not reduced during the power suppression. More specifically, in the operation mode 1, the air conditioner is operated at a rated capacity with no power suppressed. In operation mode 2, the power consumption of the compressor is reduced by 25%. In operation mode 3, the power consumption of the compressor is reduced by 50%. In operation mode 4, the power consumption of the compressor is reduced by 100%.

An amount of 11.25 kW may now be suppressed in the power consumption of the air conditioners 106a through 1061 respectively owned by the consumers 120a through 120l after a server 100a transmits a power suppression command to the consumers 120a through 120l. Three cases, case A, case B, and case C, are specifically described below.

In the example herein, the load is an air conditioner. Alternatively, the load may be a lighting device or the charger of a battery. The disclosure is applicable to the lighting device or the charger in a similar fashion as the disclosure is applied to the air conditioner. An operation mode in which the power consumption is 100% rated capacity is referred to the operation mode 1, an operation mode in which the power consumption is reduced by 25% from the rated capacity is referred to the operation mode 2, an operation mode in which the power consumption is reduced by 50% from the rated capacity is referred to the operation mode 3, and an operation mode in which the power consumption is reduced by 100% from the rated capacity is referred to the operation mode 4.

### Case A

In the case A, the contract between the aggregator and the power producer has no penalty clause. More specifically, the contract is free from penalty, and provides a low incentive. The contract may be a “power suppression contract that can be voluntarily suspended”. The first consumer 120a may now make the cancellation request of the power suppression. The indoor temperature of the first air conditioner 106a owned by the first consumer 120a may now be 25° C. (the indoor temperature detected by the first air conditioner 106a, such as the temperature of the suction air).

When the first consumer 120a makes the cancellation request of the power suppression during the power suppression period, the indoor temperature of a room A air-conditioned by the first air conditioner 106a is determined to be comfortable, namely, 25° C. The determination unit 212 in the first controller 103a configures the first air conditioner 106a owned by the first consumer 120a to be in the operation mode 1. More specifically, the determination unit 212 determines the permitted power 803 in accordance with the flowchart of the determination process of the permitted power 803 of FIG. 9. More specifically, the determination unit 212 determines in step S901 that the risk of nonfulfillment 215 of the portfolio is “low”, and the determination unit 212 configures the permitted power 803 to be at the level 1 that is a power level with all the power suppression to the first air conditioner 106a of the first consumer 120a canceled. The first controller 103a determines that the power suppression to the first air conditioner 106a is all canceled, and configures the first air conditioner 106a to be in the operation mode 1.

### Case B

In the case B, the contract between the aggregator and the power producer imposes a penalty if an achieved total amount of power suppression is lower than the target amount of suppression in the bidding. The second consumer 120b may now make the cancellation request of the power suppression. The indoor temperature of the second air conditioner 106b owned by the second consumer 120b may be 25° C.

The second consumer 120b makes the cancellation request of the power suppression during the power suppression period, and the power suppression contract includes a penalty clause. The evaluating unit 225 in the server 100 calculates the margin M. The margin M is calculated in accordance with Formula (2). Since a power consumption of 11.25 kW is suppressed in the loads of the consumers 120a through 120l, P1−Pln=11.25 kW in FIG. 10. Also with reference to FIG. 10, the margin M is expressed by the following Formula (4):

M=(P1−Pln)−DRt−DRy (4)

The target amount of suppression DRt is 10 kW, and the power suppression amount DRy imposed on the second controller 103b is 1 kW. The margin M is expressed by the following Formula (5).

M=11.25−10−1=0.25 [kW] (5)

If the predetermined threshold value X is 1 kW, and the predetermined threshold value Y is 0.1 kW, the margin M satisfies X>M>Y.

The evaluating unit 225 configures the risk of nonfulfillment 215 to be “intermediate”. More specifically, the power suppression contract includes penalty, and the margin M is higher than predetermined threshold value Y, but lower than the predetermined threshold value X. The determination results of the evaluating unit 225 is a yes branch from step S1101, a no branch from step S1103, and a yes branch from step S1105. The evaluating unit 225 performs the operation in step S1106, thereby configuring the risk of nonfulfillment 215 to be “intermediate”.

The indoor temperature of a room B air-conditioned by the second air conditioner 106b is determined to be comfortable, namely, 25° C. The determination unit 212 in the second controller 103b configures the second air conditioner 106b owned by the second consumer 120b to be in the operation mode 3.

The determination unit 212 determines the permitted power 803 as described below in accordance with the flowchart of the determination process of the permitted power 803 illustrated in FIG. 9. Since the risk of nonfulfillment 215 is configured to be “intermediate” with the degree of comfort 802 being “high”, the determination results of the determination unit 212 is a no branch from step S901, a yes branch from step S903, and a no branch from step S904 and step S906. The determination unit 212 performs the operation in step S908. The determination unit 212 configures the permitted power 803 to be at the level 3 where part of the power suppression to the second air conditioner 106b owned by the second consumer 120b is canceled. More specifically, the second controller 103b configures the power consumption to be at the level 3 where part of the power suppression to the second air conditioner 106b is canceled. In the second air conditioner 106b, 50% of the rated power (1 kW) is thus canceled.

### Case C

In the case C, the contract between the aggregator and the power producer imposes a penalty if an achieved total amount of power suppression is lower than the target amount of suppression in the bidding. The first consumer 120a may make the cancellation request of the power suppression followed by the cancellation request of the power suppression of the second consumer 120b.

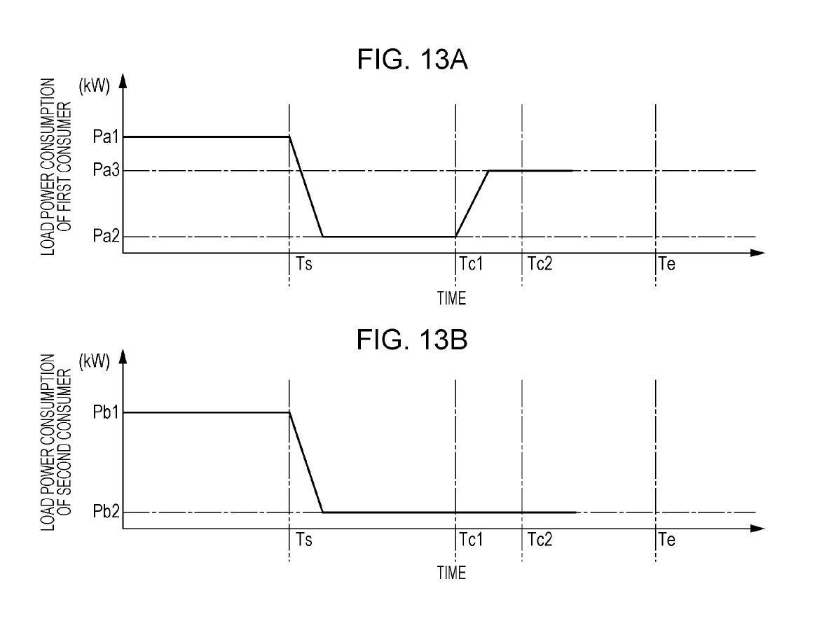

FIG. 13 illustrates a change in the load power consumption of the first consumer 120a and the second consumer 120b in the case C.

FIG. 13A illustrates a change in the load power consumption in the first consumer 120a, and FIG. 13B illustrates a change in the load power consumption in the second consumer 120b. The indoor temperature of the first air conditioner 106a owned by the first consumer 120a is 25° C., and the indoor temperature of the first air conditioner 106b owned by the first consumer 120b is 25° C.

As described with reference to the case B, the first air conditioner 106a of the first consumer 120a is in the same state as the second air conditioner 106b of the case B. The first air conditioner 106a is thus configured to be in the operation mode 3. As illustrated in FIG. 13A, the first air conditioner 106a returns to the permitted power 803 of consumption power Pa3. The second consumer 120b makes the cancellation request at timing Tc2 later than timing Tc1 at which the first consumer 120a makes the cancellation request. The second air conditioner 106b is not canceled in the power suppression, and is configured to be in the operation mode 4.

This is because the margin M is reduced by the cancellation request of the power suppression of the first consumer 120a, and thus, the margin M becomes different between before the cancellation of the power suppression to the first consumer 120a and after the cancellation to the first consumer 120a. Since the margin M is different, the level of the permitted power 803 determined by the determination unit 212 on the second air conditioner 106b of the second consumer 120b becomes different.

More specifically, when the first consumer 120a makes the cancellation request of the power suppression, the margin M is 0.25 kW as described with reference to the case B. However, if the first air conditioner 106a is operable in the operation mode 3, the margin M′ is calculated as described below.

The total amount DR′ of power suppression amount achieved subsequent to the cancellation of the power suppression to the first air conditioner 106a results from subtracting the power suppression amount DRy canceled in the first air conditioner 106a from the total amount DR of power suppression amount prior to the cancellation of power suppression to the first air conditioner 106a, and is expressed by the following Formula (6):

DR′=DR−DRy (6)

The total amount DR of power suppression amount prior to the cancellation of power suppression to the first air conditioner 106a is 11.25 kW, and the power suppression amount DRy canceled in the first air conditioner 106a is 0.50 kW. The total amount DR′ of power suppression amount achieved subsequent to the cancellation of the power suppression to the first air conditioner 106a is expressed by the following Formula (7):

DR′=11.25−0.50=10.75 [kW] (7)

The margin M′ is expressed by the following Formula (8):

M′=DR′−DRt−DRy (8)

The total amount DR′ of power suppression amount is 10.75 kW, the target amount of suppression DRt is 10 kW, and the power suppression amount DRy imposed on the second air conditioner 106b is 1 kW. The margin M′ is expressed by Formula (9):

M′=10.75−10−1=−0.25 [kW] (9)

The threshold value X is 1 kW, and the threshold value Y is 0.1 kW. The margin M′ satisfies a relationship M<Y.

The evaluating unit 225 configures the risk of nonfulfillment 215 to be “high”. More specifically, the power suppression contract includes penalty, and the margin M′ is smaller than the predetermined threshold value Y. The determination results of the evaluating unit 225 is a yes branch from step S1101, a no branch from step S1103, and a no branch from step S1105. The evaluating unit 225 thus performs the operation in step S1107. The evaluating unit 225 thus configures the risk of nonfulfillment 215 to be “high”.

The indoor temperature of the room B air-conditioned by the second air conditioner 106b is 25° C., which is considered to be comfortable. The determination unit 212 in the second controller 103b configures of the operation mode of the second air conditioner 106b of the second consumer 120b to be in the operation mode 4.

The determination unit 212 determines the permitted power 803 in accordance with the flowchart of the determination process of the permitted power 803 of FIG. 9 as described below. Since the risk of nonfulfillment 215 is configured to be “high” with the degree of comfort 802 being “high”, the determination results of the determination unit 212 is a no branch from step S901, a no branch from step S903, a no branch from step S909, and a no branch from step S911. As a result, the determination unit 212 performs the operation in step S913. The determination unit 212 configures the permitted power 803 to be at the level N that permits no cancellation to the power suppression to the second air conditioner 106b of the second consumer 120b.

More specifically, the second controller 103b configures the permitted power 803 to be in the operation mode 4 that permits no cancellation at all of the power suppression to the second air conditioner 106b.

No cancellation of the power suppression to the second air conditioner 106b of the second consumer 120b is permitted at all simply because the cancellation request of the second consumer 120b is later in timing than the cancellation of the first consumer 120a. This seems unfair to the user 107. A problem may arise that the cancellation request is to be transmitted at a very early timing in order to gain an opportunity to cancel the power suppression. The case C is unfair to a particular user, and a second embodiment configured to address this problem is described below.

In accordance with the power supply-demand control method of the first embodiment, a determination step as to whether the power suppression is cancelable or not is performed by comparing the second reference value with the interim power consumption, even if the cancellation request of the power suppression is received during the power suppression period. The target amount of suppression is at least achieved during the power suppression period even if the power suppression is canceled during the power suppression period.

### Second Embodiment

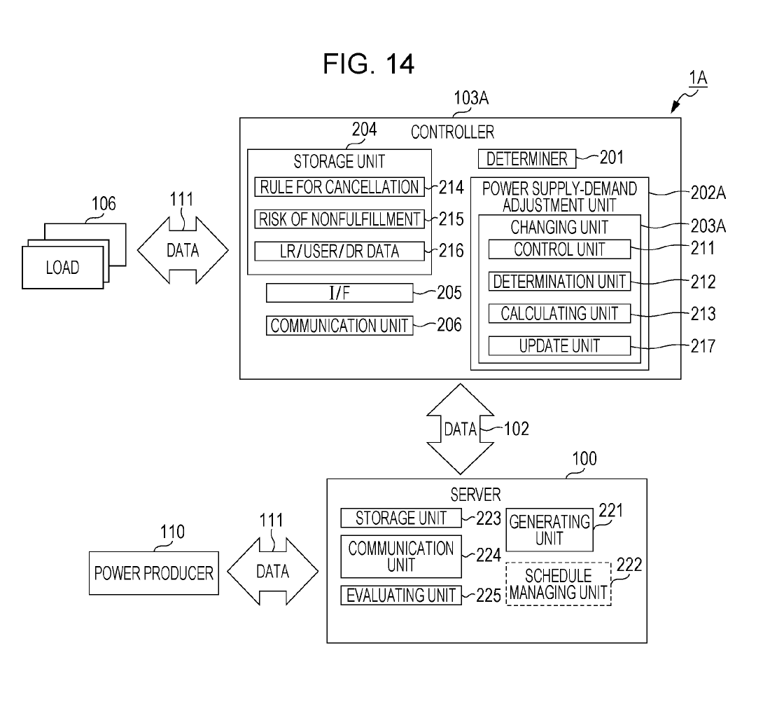

FIG. 14 is a block diagram illustrating a power supply-demand control system 1A of a second embodiment.

The power supply-demand control system 1A of the second embodiment is different from the power supply-demand control system 1 in that a changing unit 203A in a power supply-demand adjustment unit 202A in a controller 103A in a controller 103A includes an update unit 217.

Elements of the controller 103A are different from those of the controller 103. Only the difference is described below.

The controller 103A may receive a second cancellation request subsequent to first control to control the power consumption in the first consumer 120a within the first control cancellation range having the first permitted power at an upper limit thereof. The determiner 201 then determines whether the power suppression to the second consumer 120b is further cancelable.

This determination may be performed by comparing the second reference value with second interim total power consumption as the total power consumption of multiple first consumers 120a base on the assumption that the power suppression to the second consumer 120b is further canceled. The second cancellation request is to request the power suppression to the second consumer 120b from among the other consumers 120b through 120l excluding the first consumer 120a.

If the determiner 201 determines that the power suppression to the second consumer 120b is cancelable, the changing unit 203A cancels the power suppression to the second consumer 120b. The changing unit 203A includes the controller 211, the determination unit 212, the calculating unit 213, and the update unit 217.

If the determiner 201 determines that the power suppression to the second consumer 120b is further cancelable, the determination unit 212 determines the second permitted power to the second consumer 120b so that the second interim total power consumption is equal to or lower than the second reference value.

The controller 211 controls the power consumption of the second consumer 120b to within the second suppression cancellation range having the second permitted power determined by the determination unit 212 as an upper limit thereof.

If the determiner 201 determines that the power suppression to the second consumer 120b is not cancelable, the update unit 217 updates the first permitted power determined by the determination unit 212 to third permitted power that is lower in power consumption than the first permitted power. More specifically, the update unit 217 may determined the third permitted power so that the second interim total power consumption is equal to or below the second reference value.

The controller 211 controls the power consumption of the first consumer 120a to within a third suppression cancellation range having as an upper limit the third permitted power updated by the update unit 217. The controller 211 may also control the power consumption of the second consumer 120b to within the third suppression cancellation range.

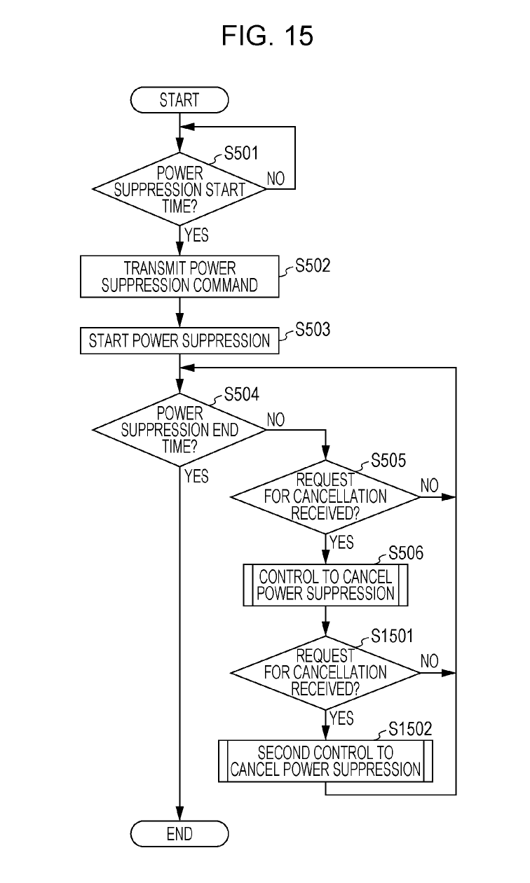

FIG. 15 is a flowchart illustrating a power suppression control method performed in the power supply-demand control system 1A of the second embodiment.

The power suppression control method of the second embodiment is different from the power suppression control method of the first embodiment in that step S1501 and step S1502 are added. Only step S1501 and step S1502 are described herein.

Subsequent to step S506, the server 100 determines whether the controller 103Ab of the second consumer 120b, different from the controller 103Aa of the first consumer 120a having made the cancellation request in step S505, receives a cancellation request (S1501). Upon determining that the cancellation request has been received (yes branch from step S1501), the server 100 performs the second cancellation control of the power suppression (S1502). Upon determining that the cancellation request has not been received (no branch from step S1501), the server 100 returns to step S504.

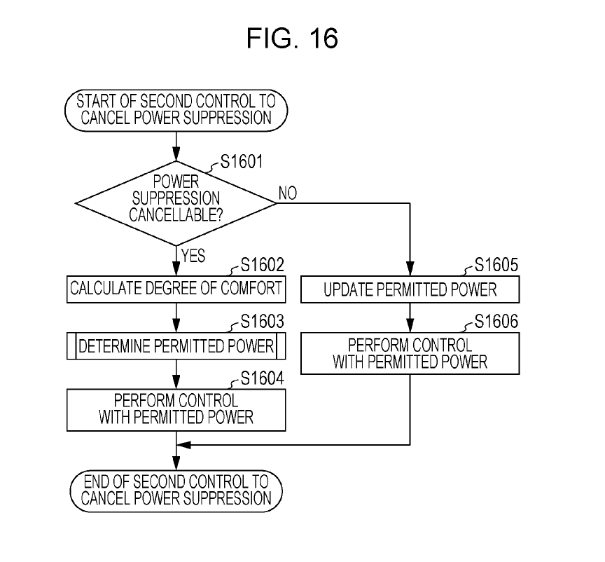

FIG. 16 is a flowchart illustrating the second cancellation control of the power suppression performed in the power supply-demand control system 1A of the second embodiment.

The determiner 201 in the second controller 103Ab of the second consumer 120b determines whether the power suppression is cancelable (S1601). If the determiner 201 determines that the power suppression is cancelable (yes branch from step S1601), the changing unit 203 performs operations in steps S1602 through S1604 to cancel the power suppression. More specifically, the calculating unit 213 calculates the degree of comfort 802 (S1602). The determination unit 212 determines the permitted power 803 (S1603). The controller 211 controls the second air conditioner 106b in accordance with the determined permitted power 803 (S1604).

If the determiner 201 determines that the power suppression is not cancelable (no branch from S1601), the update unit 217 updates the first permitted power determined by the determination unit 212 to the third permitted power lower in power consumption than the first permitted power (S1605). The controller 211 controls the power consumption of the first consumer 120a to within the third suppression cancellation range having as an upper limit thereof the third permitted power updated by the update unit 217 (S1606).

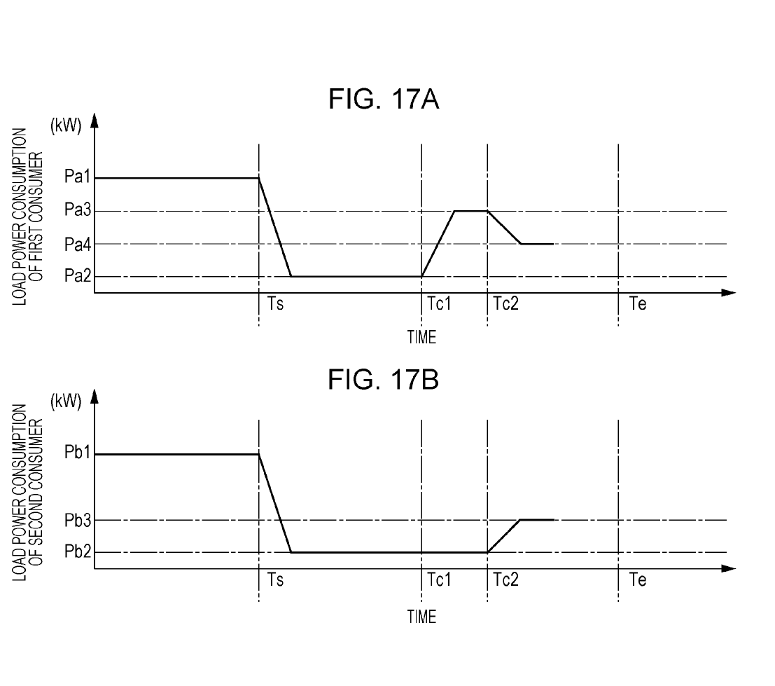

FIG. 17 illustrates a change in the load power consumption in the first consumer 120a and the second consumer 120b when the power suppression control method of the power supply-demand control system 1A of the second embodiment applies to the case C of the first embodiment.

Referring to FIG. 17A, if the first consumer 120a makes the cancellation request of the power suppression at timing Tc1, the cancellation control of the power suppression identical to the case C is performed. The first air conditioner 106a is configured to be in the operation mode 3. If the second consumer 120b makes the cancellation request of the power suppression later at timing Tc2, no sufficient margin M′ is available in the case C of the first embodiment. As a result, the determiner 201 determines in step S1601 of FIG. 16 that the power suppression is not cancelable. The update unit 217 in the second controller 103Ab updates the permitted power 803 to the controller 103Aa via the server 100 to the third permitted power Pa4 that is lower in power consumption than the first permitted power Pa3 (namely, the permitted power at the level 3). In this case, the update unit 217 updates the permitted power 803 so that the permitted power Pa4 to the first air conditioner 106a equals the permitted power Pb3 to the first air conditioner 106b. If the first consumer 120a and the second consumer 120b are different in cancellation timing of the power suppression, the first consumer 120a and the second consumer 120b return to the equal permitted power 803. The cancellation control of the power suppression is thus fairly performed.

### First Modification

In the power supply-demand control systems 1 and 1A of the first and second embodiments, the interface (I/F) 205 in the controller 103 and the first controller 103A may function as a notification unit. If the determiner 201 determines that the power control to the consumer is not cancelable, a display in the I/F 205 may function as a notification unit that notifies the user that the power suppression is not cancelable.

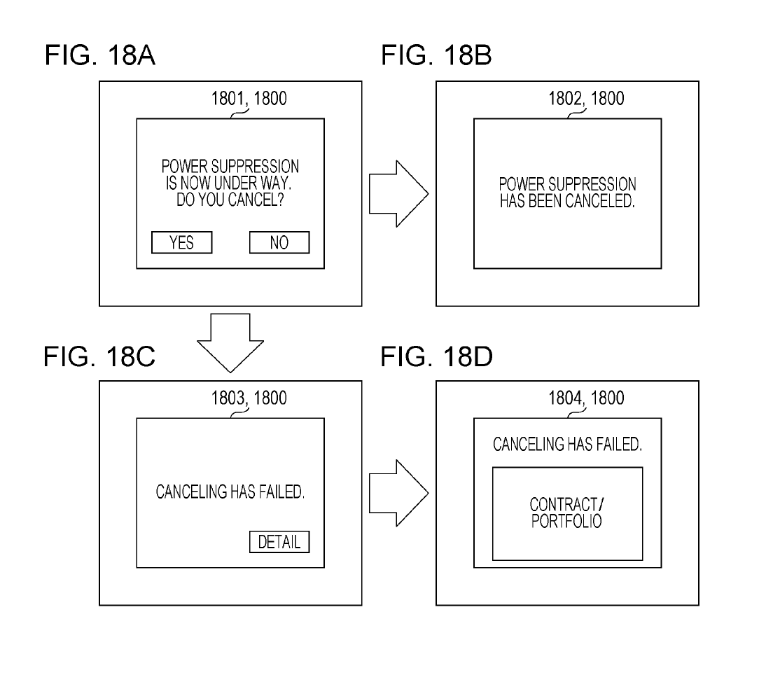

FIGS. 18A to 18D illustrate a specific example of a display screen displayed by a display 1800 implemented by the I/F 205.

FIG. 18A illustrates an example of a screen 1801 displayed on the display 1800 implemented by the I/F 205 of the controller 103 and the controller 103A when the consumer makes the cancellation request of the power suppression. The screen 1801 indicates a message “Power suppression is now under way. Do you cancel?” if the consumer makes the cancellation request of the power suppression. The message “Power suppression is under way” is an example of image data that indicates that the load is in the power suppression period. Displayed along with the message are a “yes” button to validate the cancellation of the power suppression and a “no” button to cancel the cancellation of the power suppression. The message “Do you cancel?”, the “yes” button, and the “no” button are an example of the image data that is used to cause the user to confirm that changing to the second operation mode is acceptable. If the consumer presses the “yes” button on the screen 1801, the determiner 201 in each of the controller 103 and the controller 103A determines whether the power suppression is cancelable. If the determiner 201 determines that the power suppression is cancelable, a message indicating the power suppression has been canceled is displayed as illustrated on a screen 1802 of FIG. 18B. If the determiner 201 determines that the power suppression is not cancelable, a message indicating that canceling has failed is displayed on a screen 1803 of FIG. 18C. The message indicating that canceling has failed is an example of the image data indicating that changing to the second operation mode is not permitted. A “detail” button is displayed along with the message to display detailed information for the reason that the power suppression is not cancelable. If the “detail” button is pressed on the screen 1803, the display 1800 displays a screen 1804 of FIG. 8D. The screen 1804 displays the contract information of the power suppression and information of the portfolio.

If canceling has failed, the consumer may confirm the contract information serving as a criterion of determination, or the portfolio along with the notification that the canceling has failed. Such a power supply-demand control system is convenient for the user. The display 1800 may not necessarily be included in the controller 103. A remote control or a user mobile terminal may include the display 1800.

### Second Modification

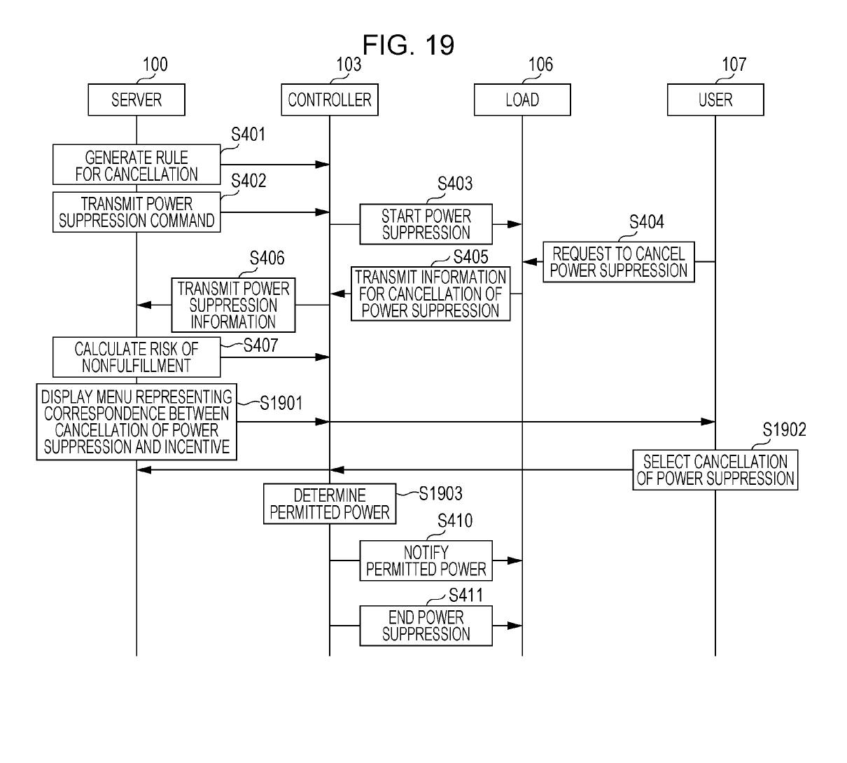

Referring to FIG. 19, in a second modification, the server 100 not only configures the returning level (namely, the permitted power) of the load 106 in response to the cancellation of the power suppression, but provides to the user a list of multiple options in the cancellation of the power suppression, and thus adjusts incentives to be paid.

When the user requests a change in the state of the power suppression, the server 100 calculates the risk of nonfulfillment 215 of the power suppression portfolio resulting from the cancellation of the power suppression. The server 100 may determine permitted power together with an amount of change in the incentive resulting from the cancellation request of the power suppression.

In the second modification, in step S1901, the server 100 presents a menu of options, namely, multiple combinations of permitted power responsive to the cancellation request of the power suppression from the user and the change in the incentive. In step S1902, the user selects an option desired from the menu provided by the server 100. When the user determines an option from the presented menu, the server 100 determines the permitted power in accordance with the rule for cancellation 214 and the determined option in step S1903. The operations described above are performed by the server 100 or the controller 103.

The server 100 may calculate a decrease in the incentive based on the canceled power suppression amount in the rule for cancellation 214, and transmits the rule for cancellation 214 to the controller 103 in advance. The controller 103 produces the menu based on the rule for cancellation 214 determined by the server 100.

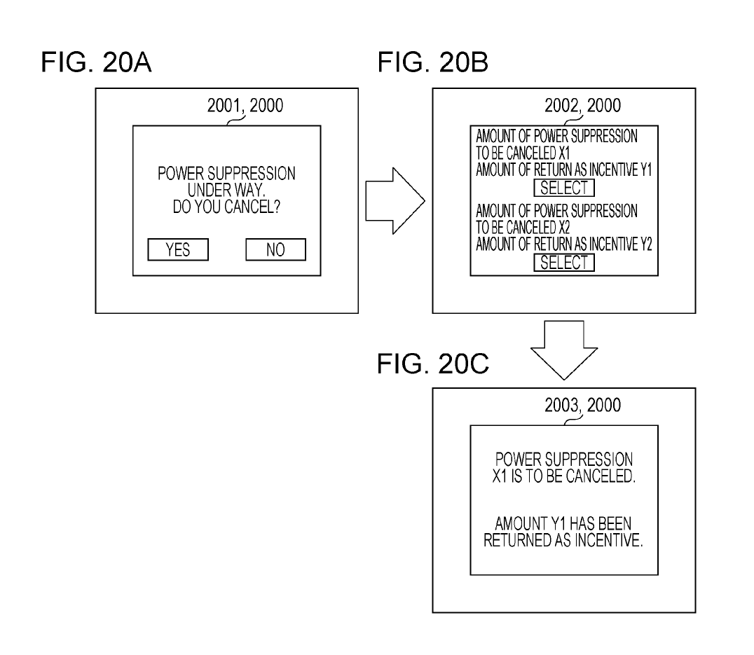

The server 100 or the controller 103 may communicate with the user using a user interface (UI) of FIGS. 20A to 20C. When the user makes the cancellation request of the power suppression, the UI displays to the user on a screen 2001 of a display 2000 the image data indicating that it is in the power suppression period, and the image data causing the user to confirm that the changing to the second operation mode is acceptable.

If the user selects the option to cancel the power suppression on a screen 2001, the UI displays, on a screen 2002, multiple options indicating correspondence between an index indicative of the power suppression amount to be canceled and an index indicative of a change in the incentive to the power suppression amount to be canceled. If the user selects an option from the menu on the screen 2002, a screen 2003 is displayed to indicate the selection result. In accordance with the option, the load 106 is controlled by the server 100 or the controller 103.

The returning amount of incentive displayed on the screen 2002 is an example of incentive information of an incentive the consumer may gain by changing to the second operation mode. The returning amount of incentive is a difference between an incentive with the power suppression not canceled and an incentive with a predetermined power suppression amount canceled. The incentive information of an incentive the consumer may gain by changing to the second operation mode is not limited to the returning amount. An index is acceptable as long as the index is related to the incentive information of an incentive the consumer may gain by changing to the second operation mode. For example, the incentive information may be related to an incentive itself the consumer gains by canceling the predetermined power suppression amount.

The controller 103 or the server 100 has a default configuration. If the user does not select any option, the controller 103 or the server 100 may account for the default configuration. The default configuration may be entered by the user or the server 100.

### Third Modification

In the power supply-demand control systems 1 and 1A of the first and second embodiments, power suppressed during the power suppression period is used during a peak-cut period. The disclosure is not limited to this method. The power suppression amount corresponding to at least the target amount of suppression is used not only during the peak cut period but also for backup power supply.

The backup power supply means the supply of backup power when the power supply from a power system becomes insufficient due to an irregular event. The irregular events may include a sharp increase in the demand due to a sudden change of weather, an interruption of the power system, and an occurrence of any event that needs power output suppression.

If the power suppression amount is used as the backup power supply in a manner different from use in the peak cut, the power suppression period is configured to be a period from a timing at which a start command of the power suppression is received from the server 100 to a timing at which an end command of the power suppression is received, rather than the specified power suppression period.

The power supply-demand method performed by the power supply-demand control systems 1 and 1A may include at least the following power supply-demand control method.

The power supply-demand control method of a power supply-demand control system configured to adjust power supply-demand between a consumer and a power system by controlling electric equipment via a communication network during a supply-demand adjustment period, includes suppressing power consumption of the consumer below a power consumption level prior to a start of the supply-demand adjustment period by changing an operation mode of the electric equipment in operation to a first operation mode if the supply-demand adjustment period starts in response to reception of a reduction request requesting the consumer to reduce power consumption, and selecting whether to permit the operation mode to change from the first operation mode to a second operation mode higher in power consumption of the electric equipment than the first operation mode if a request for changing the operation mode to the second operation mode is received with the electric equipment operating in the first operation mode during the supply-demand adjustment period.

Specifically, the power supply-demand control method may be applicable to frequency control as an example of demand response.

The request for changing is received during the supply-demand adjustment period throughout which the electric equipment (including a battery) as a target of the frequency control operates in the first operation mode. In response to the request for changing, the electric equipment is caused to operate in the first operation mode (such as a frequency control mode). More specifically, the power suppression of the electric equipment (charge and discharge amount if the electric equipment is the battery) is controlled so that the electric equipment is adjusted to a target frequency indicated by the request for changing. If the request for changing is received during the power supply-demand adjustment period, it is determined whether the electric equipment is controlled to a predetermined target frequency during an adjustment period even when the electric equipment is changed to the second operation mode (such as a operation mode of canceling the frequency control). If it is determined that the electric equipment is enabled to be controlled to the predetermined target frequency in the second operation mode, operation contents of the electric equipment are changed from the first operation mode to the second operation mode.

The disclosure is useful in the power supply-demand control method and the power supply-demand control system for appropriately selecting whether to cancel the power suppression when the cancellation request of the power supply-demand adjustment is received from the consumer during the adjustment period of the power supply and demand.

What is claimed is:

1. A power supply-demand control method of a power supply-demand control system configured to adjust power supply-demand between a consumer and a power system by controlling electric equipment via a communication network during a supply-demand adjustment period, the power supply-demand control method comprising:
receiving a request for changing the operation mode to a second operation mode higher in power consumption of the electric equipment than a first operation mode when the electric equipment operate in the first operation mode, in which power consumption of the consumer is suppressed, during the supply-demand adjustment period; and
determining whether to permit the operation mode to change from the first operation mode to the second operation mode if a request for changing the operation mode to the second operation mode is received.

2. The power supply-demand control method according to claim 1, further comprising suppressing power consumption of the consumer below a power consumption level prior to a start of the supply-demand adjustment period by starting the supply-demand adjustment period and changing an operation mode of the electric equipment in operation to a first operation mode in response to reception of a reduction request requesting the consumer to reduce power consumption.

3. The power supply-demand control method according to claim 2, further comprising causing the electric equipment to continuously operate in the first operation mode without changing from the first operation mode to the second operation mode if changing to the second operation mode is determined not to be permitted.

4. The power supply-demand control method according to claim 2, further comprising:
determining whether a predetermined supply-demand adjustment quantity is achievable during the supply-demand adjustment period in case of changing the operation mode of the electric equipment from the first operation mode to the second operation mode in response to the request for changing;
changing the operation mode of the electric equipment from the first operation mode to the second operation if the predetermined supply-demand adjustment quantity is determined to be achievable with the operation mode changed to the second operation mode; and
causing the electric equipment to continuously operate in the first operation mode without changing the operation mode of the electric mode if the predetermined supply-demand adjustment quantity is determined not to be achievable with the operation mode changed to the second operation mode.

5. The power supply-demand control method according to claim 1, further comprising:
permitting the change to the second mode when an increased amount of power consumption of the consumer accompanied by the change to the second mode is a first increased amount; and
prohibiting the change to the second mode when the increased amount of power consumption of the consumer when the increased amount of power consumption of the consumer accompanied by the change to the second mode is a second increased amount higher than the first increased amount.

6. The power supply-demand control method according to claim 1, further comprising:
permitting the change to the second mode when power consumption of the consumer is first power consumption in reception of a changing request; and
prohibiting the change to the second mode when power consumption of the consumer is second power consumption higher than first power consumption in reception of the changing request.

7. The power supply-demand control method according to claim 2, further comprising causing a display, in response to reception of a changing request to the second operation mode, to display image data indicating the supply-demand adjustment period and image data that is used to cause a user as the consumer to confirm whether or not changing to the second operation mode is acceptable; and
controlling the electric equipment in accordance with an user's answer as to whether or not changing to the second operation mode is acceptable after the image data is displayed on the display.

8. The power supply-demand control method according to claim 7, further comprising:
determining whether to permit the operation mode to change from the first operation mode to the second operation mode in response to reception of the user's answer instructing the operation mode to change to the second operation mode; and
causing the display to display image data indicating that changing to the second operation mode is not permitted if the changing to the second operation mode is determined not to be permitted.

9. The power supply-demand control method according to claim 7, further comprising causing the electric equipment to continuously operate in the first operation mode without changing from the first operation mode to the second operation mode if the answer that the user intends to cancel the changing to the second operation mode are received after the image data is displayed on the display.

10. The power supply-demand control method according to claim 7, further comprising displaying, on the display, image data indicating incentive information about an incentive the consumer is offered by changing the operation mode of the electric equipment from the first operation mode to the second operation mode.

11. The power supply-demand control method according to claim 7, further comprising:
displaying, on the display, a plurality of options indicative of correspondences between an index indicating a power suppression amount to be canceled and an index indicating a change in the incentive responsive to the power suppression amount to be canceled when the user's answer instructing the operation mode to change to the second operation mode is received; and
controlling the electric equipment in accordance with an option selected by the user.

12. The power supply-demand control method according to claim 1, further comprising determining to change the operation mode of the electric equipment from the first operation mode to a third operation mode in which power consumption of the electric equipment is higher than in the first operation mode and lower than in the second operation mode, if the changing to the second operation mode is determined not to be permitted.

13. The power supply-demand control method according to claim 1, further comprising:
adjusting the power supply-demand between the power system and a plurality of consumers;
determining whether power suppression to a first consumer is cancelable in view of total power consumption of the plurality of consumers with the power suppression to the first consumer canceled if a first cancellation request to cancel the power suppression to the first consumer from among the plurality of consumers is received; and
canceling the power suppression to the first consumer if the power suppression to the first consumer is determined to be cancelable.

14. The power supply-demand control method according to claim 13, further comprising:
determining first permitted power to the first consumer so that the total power consumption is equal to or below a predetermined reference value if the power suppression to the first consumer is determined to be cancelable; and
controlling power consumption of the first consumer to be equal to or below the first permitted power.

15. The power supply-demand control method according to claim 14, further comprising:
calculating a degree of comfort indicating comfort of the consumer in the operation mode of the electric equipment; and
determining the first permitted power to be lower as the calculated degree of comfort becomes higher.

16. The power supply-demand control method according to claim 13, further comprising:
determining whether power suppression to a second consumer is cancelable in view of total power consumption of the plurality of consumers with the power suppression to the second consumer canceled if a second cancellation request to cancel the power suppression to the second consumer from among the plurality of consumers is received after canceling the power suppression to the first consumer; and
changing operation mode of the electric equipment of the first consumer from the second operation mode to a third operation mode in which power consumption of the electric equipment is higher than in the first operation mode and lower than in the second operation mode if the power suppression to the second consumer is determined to be uncancelable.

17. A power supply-demand control apparatus of a power supply-demand control system configured to adjust power supply-demand between a consumer and a power system by controlling electric equipment via a communication network during a supply-demand adjustment period, the power supply-demand control apparatus comprising:
a receiver which receives a request for changing the operation mode to a second operation mode higher in power consumption of the electric equipment than a first operation mode when the electric equipment operate in the first operation mode, in which power consumption of the consumer is suppressed, during the supply-demand adjustment period;
a controller which determines whether to permit the operation mode to change from the first operation mode to the second operation mode if a request for changing the operation mode to the second operation mode is received.
